(19) United States
(12) Patent Application Publication
(10) Pub. No.: US 2026/0052249 A1
(43) Pub. Date: Feb. 19, 2026

(54) VIDEO SIGNAL PROCESSING METHOD USING DEPENDENT QUANTIZATION AND DEVICE THEREFOR

(71) Applicant: WILUS INSTITUTE OF STANDARDS AND TECHNOLOGY INC., Gyeonggi-do (KR)

(72) Inventors: Kyungyong KIM, Gyeonggi-do (KR); Dongcheol KIM, Gyeonggi-do (KR); Juhyung SON, Gyeonggi-do (KR); Jinsam KWAK, Gyeonggi-do (KR)

(21) Appl. No.: 18/727,047

(22) PCT Filed: Jan. 5, 2023
(86) PCT No.: PCT/KR2023/000234

§ 371 Date: Jun. 18, 2025

(30) Foreign Application Priority Data
Jan. 5, 2012 (KR) 10-2022-0001419

(51) Int. Cl. H04N 19/124; H04N 19/176; H04N 19/18

(52) U.S. Cl. CPC H04N 19/124; H04N 19/176; H04N 19/18

(57) ABSTRACT

A video signal decoding device comprises a processor which: determines a particular quantizer for reconstructing a first quantized transform coefficient, the particular quantizer being one of a first quantizer and a second quantizer which are different from each other, the particular quantizer being determined on the basis of the state of the first quantized transform coefficient; reconstructs the first quantized transform coefficient on the basis of the particular quantizer to obtain a reconstructed transform coefficient; and updates the state of a second quantized transform coefficient that is reconstructed after the first quantized transform coefficient, wherein the first quantized transform coefficient and the second quantized transform coefficient are transform coefficients in the current block.

### CROSS-REFERENCE TO RELATED APPLICATIONS

This application is the National Stage filing under 35 U.S.C. 371 of International Application No. PCT/KR2023/000234, filed on Jan. 5, 2023, which claims the benefit of KR Provisional Application No. 10-2022-0001419, filed on Jan. 5, 2022, the contents of which are all hereby incorporated by reference herein in their entirety.

### TECHNICAL FIELD

The present disclosure relates to a video signal processing method and device and, more specifically, to a video signal processing method and device by which a video signal is encoded or decoded.

### BACKGROUND ART

Compression coding refers to a series of signal processing techniques for transmitting digitized information through a communication line or storing information in a form suitable for a storage medium. An object of compression encoding includes objects such as voice, video, and text, and in particular, a technique for performing compression encoding on an image is referred to as video compression. Compression coding for a video signal is performed by removing excess information in consideration of spatial correlation, temporal correlation, and stochastic correlation. However, with the recent development of various media and data transmission media, a more efficient video signal processing method and apparatus are required.

### DISCLOSURE OF INVENTION

### Technical Problem

The disclosure is to provide a video signal processing method and a device therefor, so as to increase the coding efficiency of a video signal.

### Solution to Problem

The disclosure provides a video signal processing method and an apparatus therefor.

In the disclosure, a video signal decoding device may include a processor, and the processor may determine a predetermined quantizer to reconstruct a first quantized transform coefficient, wherein the predetermined quantizer is one of a first quantizer and a second quantizer, which are different from each other, and the predetermined quantizer is determined based on a state of the first quantized transform coefficient. The processor may reconstruct the first quantized transform coefficient based on the predetermined quantizer and obtain a reconstructed transform coefficient, and the processor may update a state of a second quantized transform coefficient that is reconstructed after restoration of the first quantized transform coefficient, wherein the first quantized transform coefficient and the second quantized transform coefficient are transform coefficients in a current block.

In the disclosure, a video signal encoding device may include a processor, and the processor may obtain a bitstream decoded according to a decoding method. In addition, the disclosure may include a computer-readable non-transitory storage medium storing the bitstream. The decoding method may include an operation of determining a predetermined quantizer to reconstruct a first quantized transform coefficient, wherein the predetermined quantizer is one of a first quantizer and a second quantizer, which are different from each other, and the predetermined quantizer is determined based on a state of the first quantized transform coefficient, an operation of restoring the first quantized transform coefficient based on the predetermined quantizer and obtaining a reconstructed transform coefficient, and operation of updating a state of the second quantized transform coefficient that is reconstructed after restoration of the first quantized transform coefficient, wherein the first quantized transform coefficient and the second quantized transform coefficient are transform coefficients in a current block.

The state of the second quantized transform coefficient may be updated among a plurality of state candidates based on the first quantized transform coefficient and the state of the first quantized transform coefficient.

The plurality of state candidates may be determined based on a trellis path.

A quantizer for the state of the second quantized transform coefficient may be determined based on a parity bit of the first quantized transform coefficient.

The quantizer for the state of the first quantized transform coefficient and the quantizer for the state of the second quantized transform coefficient may be different from each other.

The quantizer for the state of the first quantized transform coefficient and the quantizer for the state of the second quantized transform coefficient may be the same.

The first quantized transform coefficient may be 0 or different from 0, and when the first quantized transform coefficient is 0, the first quantized transform coefficient may not be reconstructed and only the state of the second quantized transform coefficient may be updated.

When the first quantized transform coefficient is 0, the state of the second quantized transform coefficient may be a predetermined state.

The number of the plurality of state candidates may be determined based on a temporal layer.

The number of the plurality of state candidates may be determined based on a quantization parameter of the current block.

The number of the plurality of state candidates may be determined based on syntax elements for restoring the second quantized transform coefficient.

The number of the plurality of state candidates may be determined based on a location of the second quantized transform coefficient in the current block.

The current block may be divided into a plurality of subblocks, and the first quantized transform coefficient and the second quantized transform coefficient may be located in different subblocks.

At least one of the quantized transform coefficients in the current block may be reconstructed based on dependent quantization, and at least one of the quantized transform coefficients in the current block, excluding a quantized transform coefficient reconstructed based on the dependent quantization, may be reconstructed based on independent quantization.

The second quantized transform coefficient may be reconstructed later than the first quantized transform coefficient in a restoration order, and the restoration order may be a top-left diagonal order.

### Advantageous Effects of Invention

The present disclosure provides a method for efficiently processing a video signal.

The effects which can be acquired from the present disclosure are not limited to the above-described effects, and other unmentioned effects can be clearly understood by those skilled in the art in the art to which the present disclosure belongs from the description below.

### BRIEF DESCRIPTION OF DRAWINGS

FIG. 1 is a schematic block diagram of a video signal encoding apparatus according to an embodiment of the present invention.

FIG. 2 is a schematic block diagram of a video signal decoding apparatus according to an embodiment of the present invention.

FIG. 3 shows an embodiment in which a coding tree unit is divided into coding units in a picture.

FIG. 4 shows an embodiment of a method for signaling a division of a quad tree and a multi-type tree.

FIGS. 5 and 6 illustrate an intra-prediction method in more detail according to an embodiment of the present disclosure.

FIG. 7 illustrates the position of neighboring blocks used to construct a motion candidate list in inter prediction.

FIG. 8 is a diagram illustrating two independent scalar quantizers according to an embodiment of the disclosure.

FIG. 9 is a diagram illustrating a state transition table according to an embodiment of the disclosure.

FIG. 10 is a state transition graph according to an embodiment of the disclosure.

FIG. 11 is a diagram illustrating a process of restoring a transform coefficient according to an embodiment of the disclosure.

FIG. 12 is a diagram illustrating an optimal trellis path according to an embodiment of the disclosure.

FIG. 13 is a diagram illustrating a restoration order for transform coefficients according to an embodiment of the disclosure.

FIG. 14 is a diagram illustrating a method of updating the states of transform coefficients and syntax elements according to an embodiment of the disclosure.

FIGS. 15 to 17 are state transition graphs according to an embodiment of the disclosure.

FIG. 18 is a diagram illustrating a separate transition procedure according to an embodiment of the present disclosure.

FIG. 19 is a diagram illustrating a method of configuring the number of states based on a temporal layer according to an embodiment of the disclosure.

FIG. 20 is a diagram illustrating a quantization index for a 8×8 sized block according to an embodiment of the disclosure.

FIG. 21 and FIG. 22 are diagrams illustrating a method of changing the number of states according to an embodiment of the disclosure.

FIG. 23 is a diagram illustrating a scan order for performing dependent quantization according to an embodiment of the disclosure.

FIG. 24 is a diagram illustrating a method of processing a video signal according to an embodiment of the disclosure.

### BEST MODE FOR CARRYING OUT THE INVENTION

Terms used in this specification may be currently widely used general terms in consideration of functions in the present invention but may vary according to the intents of those skilled in the art, customs, or the advent of new technology. Additionally, in certain cases, there may be terms the applicant selects arbitrarily and in this case, their meanings are described in a corresponding description part of the present invention. Accordingly, terms used in this specification should be interpreted based on the substantial meanings of the terms and contents over the whole specification.

In this specification, ‘A and/or B’ may be interpreted as meaning ‘including at least one of A or B.’

In this specification, some terms may be interpreted as follows. Coding may be interpreted as encoding or decoding in some cases. In the present specification, an apparatus for generating a video signal bitstream by performing encoding (coding) of a video signal is referred to as an encoding apparatus or an encoder, and an apparatus that performs decoding (decoding) of a video signal bitstream to reconstruct a video signal is referred to as a decoding apparatus or decoder. In addition, in this specification, the video signal processing apparatus is used as a term of a concept including both an encoder and a decoder. Information is a term including all values, parameters, coefficients, elements, etc. In some cases, the meaning is interpreted differently, so the present invention is not limited thereto. ‘Unit’ is used as a meaning to refer to a basic unit of image processing or a specific position of a picture, and refers to an image region including both a luma component and a chroma component. Furthermore, a “block” refers to a region of an image that includes a particular component of a luma component and chroma components (i.e., Cb and Cr). However, depending on the embodiment, the terms “unit”, “block”, “partition”, “signal”, and “region” may be used interchangeably. Also, in the present specification, the term “current block” refers to a block that is currently scheduled to be encoded, and the term “reference block” refers to a block that has already been encoded or decoded and is used as a reference in a current block. In addition, the terms “luma”, “luminance”, “Y”, and the like may be used interchangeably in this specification. Additionally, in the present specification, the terms “chroma”, “chrominance”, “Cb or Cr”, and the like may be used interchangeably, and chroma components are classified into two components, Cb and Cr, and thus each chroma component may be distinguished and used. Additionally, in the present specification, the term “unit” may be used as a concept that includes a coding unit, a prediction unit, and a transform unit. A “picture” refers to a field or a frame, and depending on embodiments, the terms may be used interchangeably. Specifically, when a captured video is an interlaced video, a single frame may be separated into an odd (or cardinal or top) field and an even (or even-numbered or bottom) field, and each field may be configured in one picture unit and encoded or decoded. If the captured video is a progressive video, a single frame may be configured as a picture and encoded or decoded. In addition, in the present specification, the terms “error signal”, “residual signal”, “residue signal”, “remaining signal”, and “difference signal” may be used interchangeably. Also, in the present specification, the terms “intra-prediction mode”, “intra-prediction directional mode”, “intra-picture prediction mode”, and “intra-picture prediction directional mode” may be used interchangeably. In addition, in the present specification, the terms “motion”, “movement”, and the like may be used interchangeably. Also, in the present specification, the terms “left”, “left above”, “above”, “right above”, “right”, “right below”, “below”, and “left below” may be used interchangeably with “leftmost”, “top left”, “top”, “top right”, “right”, “bottom right”, “bottom”, and “bottom left”. Also, the terms “element” and “member” may be used interchangeably. Picture order count (POC) represents temporal position information of pictures (or frames), and may be the playback order in which displaying is performed on a screen, and each picture may have unique POC.

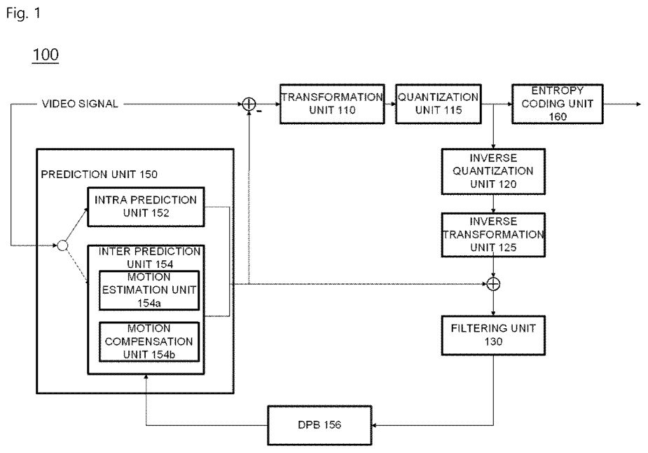

FIG. 1 is a schematic block diagram of a video signal encoding apparatus according to an embodiment of the present invention. Referring to FIG. 1, the encoding apparatus 100 of the present invention includes a transformation unit 110, a quantization unit 115, an inverse quantization unit 120, an inverse transformation unit 125, a filtering unit 130, a prediction unit 150, and an entropy coding unit 160.

The transformation unit 110 obtains a value of a transform coefficient by transforming a residual signal, which is a difference between the inputted video signal and the predicted signal generated by the prediction unit 150. For example, a Discrete Cosine Transform (DCT), a Discrete Sine Transform (DST), or a Wavelet Transform can be used. The DCT and DST perform transformation by splitting the input picture signal into blocks. In the transformation, coding efficiency may vary according to the distribution and characteristics of values in the transformation region. A transform kernel used for the transform of a residual block may has characteristics that allow a vertical transform and a horizontal transform to be separable. In this case, the transform of the residual block may be performed separately as a vertical transform and a horizontal transform. For example, an encoder may perform a vertical transform by applying a transform kernel in the vertical direction of a residual block. In addition, the encoder may perform a horizontal transform by applying the transform kernel in the horizontal direction of the residual block. In the present disclosure, the transform kernel may be used to refer to a set of parameters used for the transform of a residual signal, such as a transform matrix, a transform array, a transform function, or transform. For example, a transform kernel may be any one of multiple available kernels. Also, transform kernels based on different transform types may be used for the vertical transform and the horizontal transform, respectively.

The transform coefficients are distributed with higher coefficients toward the top left of a block and coefficients closer to “0” toward the bottom right of the block. As the size of a current block increases, there are likely to be many coefficients of “0” in the bottom-right region of the block. To reduce the transform complexity of a large-sized block, only a random top-left region may be kept and the remaining region may be reset to “0”.

In addition, error signals may be present in only some regions of a coding block. In this case, the transform process may be performed on only some random regions. In an embodiment, in a block having a size of 2N×2N, an error signal may be present only in the first 2N×N block, and the transform process may be performed on the first 2N×N block. However, the second 2N×N block may not be transformed and may not be encoded or decoded. Here, N may be any positive integer.

The encoder may perform an additional transform before transform coefficients are quantized. The above-described transform method may be referred to as a primary transform, and the additional transform may be referred to as a secondary transform. The secondary transform may be selective for each residual block. According to an embodiment, the encoder may improve coding efficiency by performing a secondary transform for regions where it is difficult to focus energy in a low-frequency region by using a primary transform alone. For example, a secondary transform may be additionally performed for blocks where residual values appear large in directions other than the horizontal or vertical direction of a residual block. Unlike a primary transform, a secondary transform may not be performed separately as a vertical transform and a horizontal transform. Such a secondary transform may be referred to as a low frequency non-separable transform (LFNST).

The quantization unit 115 quantizes the value of the transform coefficient value outputted from the transformation unit 110.

In order to improve coding efficiency, instead of coding the picture signal as it is, a method of predicting a picture using a region already coded through the prediction unit 150 and obtaining a reconstructed picture by adding a residual value between the original picture and the predicted picture to the predicted picture is used. In order to prevent mismatches in the encoder and decoder, information that can be used in the decoder should be used when performing prediction in the encoder. For this, the encoder performs a process of reconstructing the encoded current block again. The inverse quantization unit 120 inverse-quantizes the value of the transform coefficient, and the inverse transformation unit 125 reconstructs the residual value using the inverse quantized transform coefficient value. Meanwhile, the filtering unit 130 performs filtering operations to improve the quality of the reconstructed picture and to improve the coding efficiency. For example, a deblocking filter, a sample adaptive offset (SAO), and an adaptive loop filter may be included. The filtered picture is outputted or stored in a decoded picture buffer (DPB) 156 for use as a reference picture.

The deblocking filter is a filter for removing intra-block distortions generated at the boundaries between blocks in a reconstructed picture. Through the distribution of pixels included in several columns or rows based on random edges in a block, the encoder may determine whether to apply a deblocking filter to the edges. When applying a deblocking filter to the block, the encoder may apply a long filter, a strong filter, or a weak filter depending on the strength of deblocking filtering. Additionally, horizontal filtering and vertical filtering may be processed in parallel. The sample adaptive offset (SAO) may be used to correct offsets from an original video on a pixel-by-pixel basis with respect to a residual block to which a deblocking filter has been applied. To correct offset for a particular picture, the encoder may use a technique that divides pixels included in the picture into a predetermined number of regions, determines a region in which the offset correction is to be performed, and applies the offset to the region (Band Offset). Alternatively, the encoder may use a method for applying an offset in consideration of edge information of each pixel (Edge Offset). The adaptive loop filter (ALF) is a technique of dividing pixels included in a video into predetermined groups and then determining one filter to be applied to each group, thereby performing filtering differently for each group. Information about whether to apply ALF may be signaled on a per-coding unit basis, and the shape and filter coefficients of an ALF to be applied may vary for each block. In addition, an ALF filter having the same shape (a fixed shape) may be applied regardless of the characteristics of a target block to which the ALF filter is to be applied.

The prediction unit 150 includes an intra-prediction unit 152 and an inter-prediction unit 154. The intra-prediction unit 152 performs intra prediction within a current picture, and the inter-prediction unit 154 performs inter prediction to predict the current picture by using a reference picture stored in the decoded picture buffer 156. The intra-prediction unit 152 performs intra prediction from reconstructed regions in the current picture and transmits intra encoding information to the entropy coding unit 160. The intra encoding information may include at least one of an intra-prediction mode, a most probable mode (MPM) flag, an MPM index, and information regarding a reference sample. The inter-prediction unit 154 may again include a motion estimation unit 154a and a motion compensation unit 154b. The motion estimation unit 154a finds a part most similar to a current region with reference to a specific region of a reconstructed reference picture, and obtains a motion vector value which is the distance between the regions. Reference region-related motion information (reference direction indication information (L0 prediction, L1 prediction, or bidirectional prediction), a reference picture index, motion vector information, etc.) and the like, obtained by the motion estimation unit 154a, are transmitted to the entropy coding unit 160 so as to be included in a bitstream. The motion compensation unit 154B performs inter-motion compensation by using the motion information transmitted by the motion estimation unit 154a, to generate a prediction block for the current block. The inter-prediction unit 154 transmits the inter encoding information, which includes motion information related to the reference region, to the entropy coding unit 160.

According to an additional embodiment, the prediction unit 150 may include an intra block copy (IBC) prediction unit (not shown). The IBC prediction unit performs IBC prediction from reconstructed samples in a current picture and transmits IBC encoding information to the entropy coding unit 160. The IBC prediction unit references a specific region within a current picture to obtain a block vector value that indicates a reference region used to predict a current region. The IBC prediction unit may perform IBC prediction by using the obtained block vector value. The IBC prediction unit transmits the IBC encoding information to the entropy coding unit 160.

The IBC encoding information may include at least one of reference region size information and block vector information (index information for predicting the block vector of a current block in a motion candidate list, and block vector difference information).

When the above picture prediction is performed, the transform unit 110 transforms a residual value between an original picture and a predictive picture to obtain a transform coefficient value. At this time, the transform may be performed on a specific block basis in the picture, and the size of the specific block may vary within a predetermined range. The quantization unit 115 quantizes the transform coefficient value generated by the transform unit 110 and transmits the quantized transform coefficient to the entropy coding unit 160.

The quantized transform coefficients in the form of a two-dimensional array may be rearranged into a one-dimensional array for entropy coding. In relation to methods for scanning a quantized transform coefficient, the size of a transform block and an intra-picture prediction mode may determine which scanning method is used. In an embodiment, diagonal, vertical, and horizontal scans may be applied. This scan information may be signaled on a block-by-block basis, and may be derived based on predetermined rules.

The entropy coding unit 160 generates a video signal bitstream by entropy coding information indicating a quantized transform coefficient, intra encoding information, and inter encoding information. The entropy coding unit 160 may use variable length coding (VLC) and arithmetic coding. The variable length coding (VLC) is a technique of transforming input symbols into consecutive codewords, wherein the length of the codewords is variable. For example, frequently occurring symbols are represented by shorter codewords, while less frequently occurring symbols are represented by longer codewords. As the variable length coding, context-based adaptive variable length coding (CAVLC) may be used. The arithmetic coding uses the probability distribution of each data symbol to transform consecutive data symbols into a single decimal number. The arithmetic coding allows acquisition of the optimal decimal bits needed to represent each symbol. As the arithmetic coding, context-based adaptive binary arithmetic coding (CABAC) may be used.

CABAC is a binary arithmetic coding technique using multiple context models generated based on probabilities obtained from experiments. First, when symbols are not in binary form, the encoder binarizes each symbol by using exp-Golomb, etc. The binarized value, 0 or 1, may be described as a bin. A CABAC initialization process is divided into context initialization and arithmetic coding initialization. The context initialization is the process of initializing the probability of occurrence of each symbol, and is determined by the type of symbol, a quantization parameter (QP), and slice type (I, P, or B). A context model having the initialization information may use a probability-based value obtained through an experiment. The context model provides information about the probability of occurrence of Least Probable Symbol (LPS) or Most Probable Symbol (MPS) for a symbol to be currently coded and about which of bin values 0 and 1 corresponds to the MPS (valMPS). One of multiple context models is selected via a context index (ctxIdx), and the context index may be derived from information in a current block to be encoded or from information about neighboring blocks. Initialization for binary arithmetic coding is performed based on a probability model selected from the context models. In the binary arithmetic coding, encoding is performed through the process in which division into probability intervals is made through the probability of occurrence of 0 and 1, and then a probability interval corresponding to a bin to be processed becomes the entire probability interval for the next bin to be processed. Information about a position within the last bin in which the last bin has been processed is output. However, the probability interval cannot be divided indefinitely, and thus, when the probability interval is reduced to a certain size, a renormalization process is performed to widen the probability interval and the corresponding position information is output. In addition, after each bin is processed, a probability update process may be performed, wherein information about a processed bin is used to set a new probability for the next to be processed.

The generated bitstream is encapsulated in network abstraction layer (NAL) unit as basic units. The NAL units are classified into video a coding layer (VCL) NAL unit, which includes video data, and a non-VCL NAL unit, which includes parameter information for decoding video data. There are various types of VCL or non-VCL NAL units. A NAL unit includes NAL header information and raw byte sequence payload (RBSP) which is data. The NAL header information includes summary information about the RBSP. The RBSP of a VCL NAL unit includes an integer number of encoded coding tree units. In order to decode a bitstream in a video decoder, it is necessary to separate the bitstream into NAL units and then decode each of the separate NAL units. Information required for decoding a video signal bitstream may be included in a picture parameter set (PPS), a sequence parameter set (SPS), a video parameter set (VPS), etc., and transmitted.

The block diagram of FIG. 1 illustrates the encoding device 100 according to an embodiment of the present disclosure, wherein the separately shown blocks logically distinguish the elements of the encoding device 100. Accordingly, the above-described elements of the encoding device 100 may be mounted as a single chip or multiple chips, depending on the design of the device. According to an embodiment, the above-described operation of each element of the encoding device 100 may be performed by a processor (not shown).

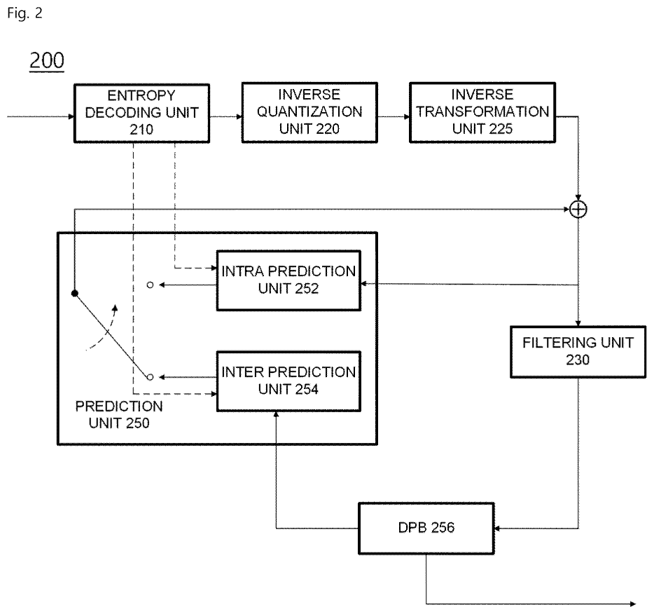

FIG. 2 is a schematic block diagram of a video signal decoding apparatus 200 according to an embodiment of the present invention. Referring to FIG. 2, the decoding apparatus 200 of the present invention includes an entropy decoding unit 210, an inverse quantization unit 220, an inverse transformation unit 225, a filtering unit 230, and a prediction unit 250.

The entropy decoding unit 210 entropy-decodes a video signal bitstream to extract transform coefficient information, intra encoding information, inter encoding information, and the like for each region. For example, the entropy decoding unit 210 may obtain a binarization code for transform coefficient information of a specific region from the video signal bitstream. The entropy decoding unit 210 obtains a quantized transform coefficient by inverse-binarizing a binary code. The inverse quantization unit 220 inverse-quantizes the quantized transform coefficient, and the inverse transformation unit 225 reconstructs a residual value by using the inverse-quantized transform coefficient. The video signal processing device 200 reconstructs an original pixel value by summing the residual value obtained by the inverse transformation unit 225 with a prediction value obtained by the prediction unit 250.

Meanwhile, the filtering unit 230 performs filtering on a picture to improve image quality. This may include a deblocking filter for reducing block distortion and/or an adaptive loop filter for removing distortion of the entire picture. The filtered picture is outputted or stored in the DPB 256 for use as a reference picture for the next picture.

The prediction unit 250 includes an intra prediction unit 252 and an inter prediction unit 254. The prediction unit 250 generates a prediction picture by using the encoding type decoded through the entropy decoding unit 210 described above, transform coefficients for each region, and intra/inter encoding information. In order to reconstruct a current block in which decoding is performed, a decoded region of the current picture or other pictures including the current block may be used. In a reconstruction, only a current picture, that is, a picture (or, tile/slice) that performs intra prediction or intra BC prediction, is called an intra picture or an I picture (or, tile/slice), and a picture (or, tile/slice) that can perform all of intra prediction, inter prediction, and intra BC prediction is called an inter picture (or, tile/slice). In order to predict sample values of each block among inter pictures (or, tiles/slices), a picture (or, tile/slice) using up to one motion vector and a reference picture index is called a predictive picture or P picture (or, tile/slice), and a picture (or tile/slice) using up to two motion vectors and a reference picture index is called a bi-predictive picture or a B picture (or tile/slice). In other words, the P picture (or, tile/slice) uses up to one motion information set to predict each block, and the B picture (or, tile/slice) uses up to two motion information sets to predict each block. Here, the motion information set includes one or more motion vectors and one reference picture index.

The intra prediction unit 252 generates a prediction block using the intra encoding information and reconstructed samples in the current picture. As described above, the intra encoding information may include at least one of an intra prediction mode, a Most Probable Mode (MPM) flag, and an MPM index. The intra prediction unit 252 predicts the sample values of the current block by using the reconstructed samples located on the left and/or upper side of the current block as reference samples. In this disclosure, reconstructed samples, reference samples, and samples of the current block may represent pixels. Also, sample values may represent pixel values.

According to an embodiment, the reference samples may be samples included in a neighboring block of the current block. For example, the reference samples may be samples adjacent to a left boundary of the current block and/or samples may be samples adjacent to an upper boundary. Also, the reference samples may be samples located on a line within a predetermined distance from the left boundary of the current block and/or samples located on a line within a predetermined distance from the upper boundary of the current block among the samples of neighboring blocks of the current block. In this case, the neighboring block of the current block may include the left (L) block, the upper (A) block, the below left (BL) block, the above right (AR) block, or the above left (AL) block.

The inter prediction unit 254 generates a prediction block using reference pictures and inter encoding information stored in the DPB 256. The inter coding information may include motion information set (reference picture index, motion vector information, etc.) of the current block for the reference block. Inter prediction may include L0 prediction, L1 prediction, and bi-prediction. L0 prediction means prediction using one reference picture included in the L0 picture list, and L1 prediction means prediction using one reference picture included in the L1 picture list. For this, one set of motion information (e.g., motion vector and reference picture index) may be required. In the bi-prediction method, up to two reference regions may be used, and the two reference regions may exist in the same reference picture or may exist in different pictures. That is, in the bi-prediction method, up to two sets of motion information (e.g., a motion vector and a reference picture index) may be used and two motion vectors may correspond to the same reference picture index or different reference picture indexes. In this case, the reference pictures are pictures located temporally before or after the current picture, and may be pictures for which reconstruction has already been completed. According to an embodiment, two reference regions used in the bi-prediction scheme may be regions selected from picture list L0 and picture list L1, respectively.

The inter prediction unit 254 may obtain a reference block of the current block using a motion vector and a reference picture index. The reference block is in a reference picture corresponding to a reference picture index. Also, a sample value of a block specified by a motion vector or an interpolated value thereof can be used as a predictor of the current block. For motion prediction with sub-pel unit pixel accuracy, for example, an 8-tap interpolation filter for a luma signal and a 4-tap interpolation filter for a chroma signal can be used. However, the interpolation filter for motion prediction in sub-pel units is not limited thereto. In this way, the inter prediction unit 254 performs motion compensation to predict the texture of the current unit from motion pictures reconstructed previously. In this case, the inter prediction unit may use a motion information set.

According to an additional embodiment, the prediction unit 250 may include an IBC prediction unit (not shown). The IBC prediction unit may reconstruct the current region by referring to a specific region including reconstructed samples in the current picture. The IBC prediction unit obtains IBC encoding information for the current region from the entropy decoding unit 210. The IBC prediction unit obtains a block vector value of the current region indicating the specific region in the current picture. The IBC prediction unit may perform IBC prediction by using the obtained block vector value. The IBC encoding information may include block vector information.

The reconstructed video picture is generated by adding the predict value outputted from the intra prediction unit 252 or the inter prediction unit 254 and the residual value outputted from the inverse transformation unit 225. That is, the video signal decoding apparatus 200 reconstructs the current block using the prediction block generated by the prediction unit 250 and the residual obtained from the inverse transformation unit 225.

Meanwhile, the block diagram of FIG. 2 shows a decoding apparatus 200 according to an embodiment of the present invention, and separately displayed blocks logically distinguish and show the elements of the decoding apparatus 200. Accordingly, the elements of the above-described decoding apparatus 200 may be mounted as one chip or as a plurality of chips depending on the design of the device. According to an embodiment, the operation of each element of the above-described decoding apparatus 200 may be performed by a processor (not shown).

The technology proposed in the present specification may be applied to a method and a device for both an encoder and a decoder, and the wording signaling and parsing may be for convenience of description. In general, signaling may be described as encoding each type of syntax from the perspective of the encoder, and parsing may be described as interpreting each type of syntax from the perspective of the decoder. In other words, each type of syntax may be included in a bitstream and signaled by the encoder, and the decoder may parse the syntax and use the syntax in a reconstruction process. In this case, the sequence of bits for each type of syntax arranged according to a prescribed hierarchical configuration may be called a bitstream.

One picture may be partitioned into sub-pictures, slices, tiles, etc. and encoded. A sub-picture may include one or more slices or tiles. When one picture is partitioned into multiple slices or tiles and encoded, all the slices or tiles within the picture must be decoded before the picture can be output a screen. On the other hand, when one picture is encoded into multiple subpictures, only a random subpicture may be decoded and output on the screen. A slice may include multiple tiles or subpictures. Alternatively, a tile may include multiple subpictures or slices. Subpictures, slices, and tiles may be encoded or decoded independently of each other, and thus are advantageous for parallel processing and processing speed improvement. However, there is the disadvantage in that a bit rate increases because encoded information of other adjacent subpictures, slices, and tiles is not available. A subpicture, a slice, and a tile may be partitioned into multiple coding tree units (CTUs) and encoded.

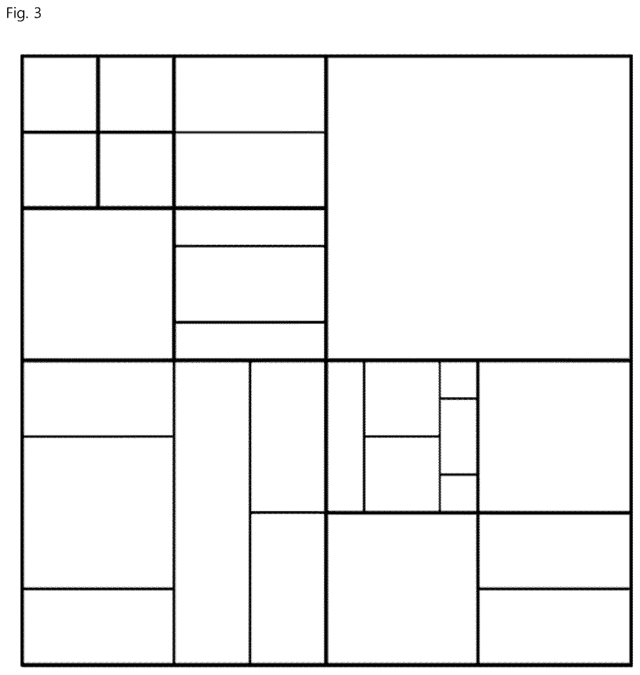

FIG. 3 illustrates an embodiment in which a coding tree unit (CTU) is divided into coding units (CUs) within a picture. In the process of coding a video signal, a picture may be divided into a sequence of coding tree units (CTUs). A coding tree unit may include a luma Coding Tree Block (CTB), two chroma coding tree blocks, and encoded syntax information thereof. One coding tree unit may include one coding unit, or one coding tree unit may be divided into multiple coding units. One coding unit may include a luma coding block (CB), two chroma coding blocks, and encoded syntax information thereof. One coding block may be partitioned into multiple sub-coding blocks. One coding unit may include one transform unit (TU), or one coding unit may be partitioned into multiple transform units. A transform unit may include a luma transform block (TB), two chroma transform blocks, and encoded syntax information thereof. A coding tree unit may be partitioned into multiple coding units. A coding tree unit may become a leaf node without being partitioned. In this case, the coding tree unit itself may be a coding unit.

The coding unit refers to a basic unit for processing a picture in the process of processing the video signal described above, that is, intra/inter prediction, transformation, quantization, and/or entropy coding. The size and shape of the coding unit in one picture may not be constant. The coding unit may have a square or rectangular shape. The rectangular coding unit (or rectangular block) includes a vertical coding unit (or vertical block) and a horizontal coding unit (or horizontal block). In the present specification, the vertical block is a block whose height is greater than the width, and the horizontal block is a block whose width is greater than the height. Further, in this specification, a non-square block may refer to a rectangular block, but the present invention is not limited thereto.

Referring to FIG. 3, the coding tree unit is first split into a quad tree (QT) structure. That is, one node having a 2N×2N size in a quad tree structure may be split into four nodes having an N×N size. In the present specification, the quad tree may also be referred to as a quaternary tree. Quad tree split can be performed recursively, and not all nodes need to be split with the same depth.

Meanwhile, the leaf node of the above-described quad tree may be further split into a multi-type tree (MTT) structure. According to an embodiment of the present invention, in a multi-type tree structure, one node may be split into a binary or ternary tree structure of horizontal or vertical division. That is, in the multi-type tree structure, there are four split structures such as vertical binary split, horizontal binary split, vertical ternary split, and horizontal ternary split. According to an embodiment of the present invention, in each of the tree structures, the width and height of the nodes may all have powers of 2. For example, in a binary tree (BT) structure, a node of a 2N×2N size may be split into two N×2N nodes by vertical binary split, and split into two 2N×N nodes by horizontal binary split. In addition, in a ternary tree (TT) structure, a node of a 2N×2N size is split into (N/2)×2N, N×2N, and (N/2)×2N nodes by vertical ternary split, and split into 2N×(N/2), 2N×N, and 2N×(N/2) nodes by horizontal ternary split. This multi-type tree split can be performed recursively.

A leaf node of the multi-type tree can be a coding unit. When the coding unit is not greater than the maximum transform length, the coding unit can be used as a unit of prediction and/or transform without further splitting. As an embodiment, when the width or height of the current coding unit is greater than the maximum transform length, the current coding unit can be split into a plurality of transform units without explicit signaling regarding splitting. On the other hand, at least one of the following parameters in the above-described quad tree and multi-type tree may be predefined or transmitted through a higher level set of RBSPs such as PPS, SPS, VPS, and the like. 1) CTU size: root node size of quad tree, 2) minimum QT size MinQtSize: minimum allowed QT leaf node size, 3) maximum BT size MaxBtSize: maximum allowed BT root node size, 4) Maximum TT size MaxTtSize: maximum allowed TT root node size, 5) Maximum MTT depth MaxMttDepth: maximum allowed depth of MTT split from QT's leaf node, 6) Minimum BT size MinBtSize: minimum allowed BT leaf node size, 7) Minimum TT size MinTtSize: minimum allowed TT leaf node size.

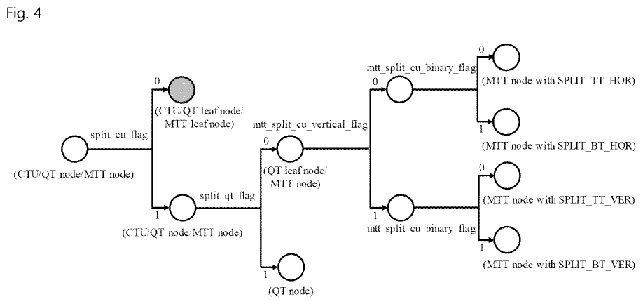

FIG. 4 illustrates an embodiment of a method of signaling splitting of the quad tree and multi-type tree. Preset flags can be used to signal the splitting of the quad tree and multi-type tree described above. Referring to FIG. 4, at least one of a flag ‘split_cu_flag’ indicating whether or not to split a node, a flag ‘split_qt_flag’ indicating whether or not to split a quad tree node, a flag ‘mtt_split_cu_vertical_flag’ indicating a splitting direction of the multi-type tree node, or a flag ‘mtt_split_cu_binary_flag’ indicating a splitting shape of the multi-type tree node can be used.

According to an embodiment of the present invention, ‘split_cu_flag’, which is a flag indicating whether or not to split the current node, can be signaled first. When the value of ‘split_cu_flag’ is 0, it indicates that the current node is not split, and the current node becomes a coding unit. When the current node is the coating tree unit, the coding tree unit includes one unsplit coding unit. When the current node is a quad tree node ‘QT node’, the current node is a leaf node ‘QT leaf node’ of the quad tree and becomes the coding unit. When the current node is a multi-type tree node ‘MTT node’, the current node is a leaf node ‘MTT leaf node’ of the multi-type tree and becomes the coding unit.

When the value of ‘split_cu_flag’ is 1, the current node can be split into nodes of the quad tree or multi-type tree according to the value of ‘split_qt_flag’. A coding tree unit is a root node of the quad tree, and can be split into a quad tree structure first. In the quad tree structure, ‘split_qt_flag’ is signaled for each node ‘QT node’. When the value of ‘split_qt_flag’ is 1, the corresponding node is split into 4 square nodes, and when the value of ‘qt_split_flag’ is 0, the corresponding node becomes the ‘QT leaf node’ of the quad tree, and the corresponding node is split into multi-type nodes. According to an embodiment of the present invention, quad tree splitting can be limited according to the type of the current node. Quad tree splitting can be allowed when the current node is the coding tree unit (root node of the quad tree) or the quad tree node, and quad tree splitting may not be allowed when the current node is the multi-type tree node. Each quad tree leaf node ‘QT leaf node’ can be further split into a multi-type tree structure. As described above, when ‘split_qt_flag’ is 0, the current node can be split into multi-type nodes. In order to indicate the splitting direction and the splitting shape, ‘mtt_split_cu_vertical_flag’ and ‘mtt_split_cu_binary_flag’ can be signaled. When the value of ‘mtt_split_cu_vertical_flag’ is 1, vertical splitting of the node ‘MTT node’ is indicated, and when the value of ‘mtt_split_cu_vertical_flag’ is 0, horizontal splitting of the node ‘MTT node’ is indicated. In addition, when the value of ‘mtt_split_cu_binary_flag’ is 1, the node ‘MTT node’ is split into two rectangular nodes, and when the value of ‘mtt_split_cu_binary_flag’ is 0, the node ‘MTT node’ is split into three rectangular nodes.

In the tree partitioning structure, a luma block and a chroma block may be partitioned in the same form. That is, a chroma block may be partitioned by referring to the partitioning form of a luma block. When a current chroma block is less than a predetermined size, a chroma block may not be partitioned even if a luma block is partitioned.

In the tree partitioning structure, a luma block and a chroma block may have different forms. In this case, luma block partitioning information and chroma block partitioning information may be signaled separately. Furthermore, in addition to the partitioning information, luma block encoding information and chroma block encoding information may also be different from each other. In one example, the luma block and the chroma block may be different in at least one among intra encoding mode, encoding information for motion information, etc.

A node to be split into the smallest units may be treated as one coding block. When a current block is a coding block, the coding block may be partitioned into several sub-blocks (sub-coding blocks), and the sub-blocks may have the same prediction information or different pieces of prediction information. In one example, when a coding unit is in an intra mode, intra-prediction modes of sub-blocks may be the same or different from each other. Also, when the coding unit is in an inter mode, sub-blocks may have the same motion information or different pieces of the motion information. Furthermore, the sub-blocks may be encoded or decoded independently of each other. Each sub-block may be distinguished by a sub-block index (sbIdx). Also, when a coding unit is partitioned into sub-blocks, the coding unit may be partitioned horizontally, vertically, or diagonally. In an intra mode, a mode in which a current coding unit is partitioned into two or four sub-blocks horizontally or vertically is called intra sub-partitions (ISP). In an inter mode, a mode in which a current coding block is partitioned diagonally is called a geometric partitioning mode (GPM). In the GPM mode, the position and direction of a diagonal line are derived using a predetermined angle table, and index information of the angle table is signaled.

Picture prediction (motion compensation) for coding is performed on a coding unit that is no longer divided (i.e., a leaf node of a coding unit tree). Hereinafter, the basic unit for performing the prediction will be referred to as a “prediction unit” or a “prediction block”.

Hereinafter, the term “unit” used herein may replace the prediction unit, which is a basic unit for performing prediction. However, the present disclosure is not limited thereto, and “unit” may be understood as a concept broadly encompassing the coding unit.

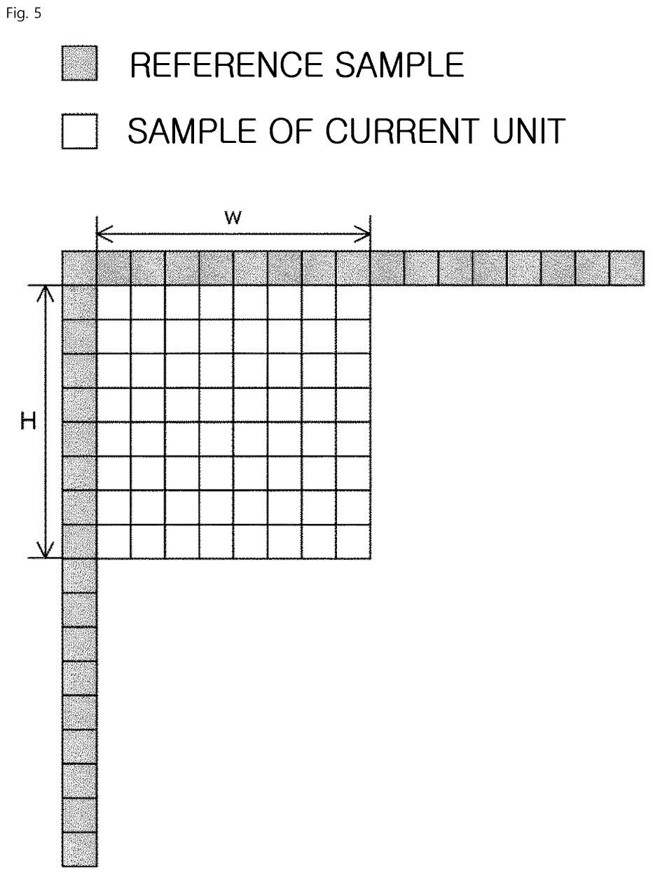

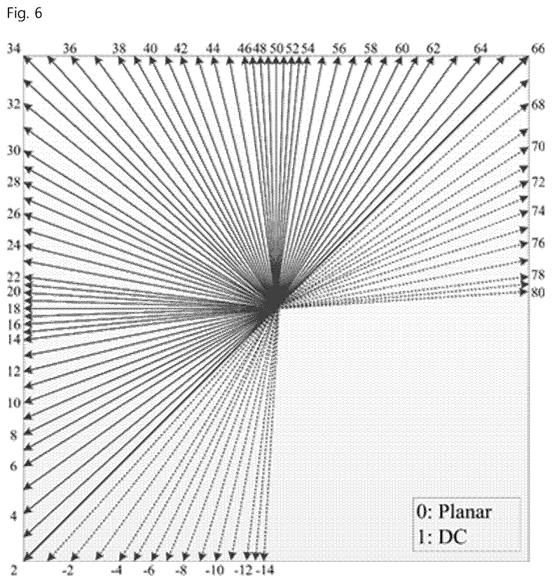

FIGS. 5 and 6 more specifically illustrate an intra prediction method according to an embodiment of the present invention. As described above, the intra prediction unit predicts the sample values of the current block by using the reconstructed samples located on the left and/or upper side of the current block as reference samples.

First, FIG. 5 shows an embodiment of reference samples used for prediction of a current block in an intra prediction mode. According to an embodiment, the reference samples may be samples adjacent to the left boundary of the current block and/or samples adjacent to the upper boundary. As shown in FIG. 5, when the size of the current block is W×H and samples of a single reference line adjacent to the current block are used for intra prediction, reference samples may be configured using a maximum of 2 W+2H+1 neighboring samples located on the left and/or upper side of the current block.

Pixels from multiple reference lines may be used for intra prediction of the current block. The multiple reference lines may include n lines located within a predetermined range from the current block. According to an embodiment, when pixels from multiple reference lines are used for intra prediction, separate index information that indicates lines to be set as reference pixels may be signaled, and may be named a reference line index.

When at least some samples to be used as reference samples have not yet been reconstructed, the intra prediction unit may obtain reference samples by performing a reference sample padding procedure. The intra prediction unit may perform a reference sample filtering procedure to reduce an error in intra prediction. That is, filtering may be performed on neighboring samples and/or reference samples obtained by the reference sample padding procedure, so as to obtain the filtered reference samples. The intra prediction unit predicts samples of the current block by using the reference samples obtained as in the above. The intra prediction unit predicts samples of the current block by using unfiltered reference samples or filtered reference samples. In the present disclosure, neighboring samples may include samples on at least one reference line. For example, the neighboring samples may include adjacent samples on a line adjacent to the boundary of the current block.

Next, FIG. 6 shows an embodiment of prediction modes used for intra prediction. For intra prediction, intra prediction mode information indicating an intra prediction direction may be signaled. The intra prediction mode information indicates one of a plurality of intra prediction modes included in the intra prediction mode set. When the current block is an intra prediction block, the decoder receives intra prediction mode information of the current block from the bitstream. The intra prediction unit of the decoder performs intra prediction on the current block based on the extracted intra prediction mode information.

According to an embodiment of the present invention, the intra prediction mode set may include all intra prediction modes used in intra prediction (e.g., a total of 67 intra prediction modes). More specifically, the intra prediction mode set may include a planar mode, a DC mode, and a plurality (e.g., 65) of angle modes (i.e., directional modes). Each intra prediction mode may be indicated through a preset index (i.e., intra prediction mode index). For example, as shown in FIG. 6, the intra prediction mode index 0 indicates a planar mode, and the intra prediction mode index 1 indicates a DC mode. Also, the intra prediction mode indexes 2 to 66 may indicate different angle modes, respectively. The angle modes respectively indicate angles which are different from each other within a preset angle range. For example, the angle mode may indicate an angle within an angle range (i.e., a first angular range) between 45 degrees and −135 degrees clockwise. The angle mode may be defined based on the 12 o'clock direction. In this case, the intra prediction mode index 2 indicates a horizontal diagonal (HDIA) mode, the intra prediction mode index 18 indicates a horizontal (Horizontal, HOR) mode, the intra prediction mode index 34 indicates a diagonal (DIA) mode, the intra prediction mode index 50 indicates a vertical (VER) mode, and the intra prediction mode index 66 indicates a vertical diagonal (VDIA) mode.

Meanwhile, the preset angle range can be set differently depending on a shape of the current block. For example, if the current block is a rectangular block, a wide angle mode indicating an angle exceeding 45 degrees or less than −135 degrees in a clockwise direction can be additionally used. When the current block is a horizontal block, an angle mode can indicate an angle within an angle range (i.e., a second angle range) between (45+offset1) degrees and (−135+offset1) degrees in a clockwise direction. In this case, angle modes 67 to 76 outside the first angle range can be additionally used. In addition, if the current block is a vertical block, the angle mode can indicate an angle within an angle range (i.e., a third angle range) between (45−offset2) degrees and (−135−offset2) degrees in a clockwise direction. In this case, angle modes −10 to −1 outside the first angle range can be additionally used. According to an embodiment of the present disclosure, values of offset1 and offset2 can be determined differently depending on a ratio between the width and height of the rectangular block. In addition, offset1 and offset2 can be positive numbers.

According to a further embodiment of the present invention, a plurality of angle modes configuring the intra prediction mode set can include a basic angle mode and an extended angle mode. In this case, the extended angle mode can be determined based on the basic angle mode.

According to an embodiment, the basic angle mode is a mode corresponding to an angle used in intra prediction of the existing high efficiency video coding (HEVC) standard, and the extended angle mode can be a mode corresponding to an angle newly added in intra prediction of the next generation video codec standard. More specifically, the basic angle mode can be an angle mode corresponding to any one of the intra prediction modes {2, 4, 6, . . . , 66}, and the extended angle mode can be an angle mode corresponding to any one of the intra prediction modes {3, 5, 7, . . . , 65}.

That is, the extended angle mode can be an angle mode between basic angle modes within the first angle range. Accordingly, the angle indicated by the extended angle mode can be determined on the basis of the angle indicated by the basic angle mode.

According to another embodiment, the basic angle mode can be a mode corresponding to an angle within a preset first angle range, and the extended angle mode can be a wide angle mode outside the first angle range. That is, the basic angle mode can be an angle mode corresponding to any one of the intra prediction modes {2, 3, 4, . . . , 66}, and the extended angle mode can be an angle mode corresponding to any one of the intra prediction modes {−14, −13, −12, . . . , −1} and {67, 68, . . . , 80}. The angle indicated by the extended angle mode can be determined as an angle on a side opposite to the angle indicated by the corresponding basic angle mode. Accordingly, the angle indicated by the extended angle mode can be determined on the basis of the angle indicated by the basic angle mode. Meanwhile, the number of extended angle modes is not limited thereto, and additional extended angles can be defined according to the size and/or shape of the current block. Meanwhile, the total number of intra prediction modes included in the intra prediction mode set can vary depending on the configuration of the basic angle mode and extended angle mode described above

In the embodiments described above, the spacing between the extended angle modes can be set on the basis of the spacing between the corresponding basic angle modes. For example, the spacing between the extended angle modes {3, 5, 7, . . . , 65} can be determined on the basis of the spacing between the corresponding basic angle modes {2, 4, 6, . . . , 66}. In addition, the spacing between the extended angle modes {−14, −13, . . . , −1} can be determined on the basis of the spacing between corresponding basic angle modes {53, 54, . . . , 66} on the opposite side, and the spacing between the extended angle modes {67, 68, . . . , 80} can be determined on the basis of the spacing between the corresponding basic angle modes {2, 3, 4, . . . , 15} on the opposite side. The angular spacing between the extended angle modes can be set to be the same as the angular spacing between the corresponding basic angle modes. In addition, the number of extended angle modes in the intra prediction mode set can be set to be less than or equal to the number of basic angle modes.

According to an embodiment of the present invention, the extended angle mode can be signaled based on the basic angle mode. For example, the wide angle mode (i.e., the extended angle mode) can replace at least one angle mode (i.e., the basic angle mode) within the first angle range. The basic angle mode to be replaced can be a corresponding angle mode on a side opposite to the wide angle mode. That is, the basic angle mode to be replaced is an angle mode that corresponds to an angle in an opposite direction to the angle indicated by the wide angle mode or that corresponds to an angle that differs by a preset offset index from the angle in the opposite direction. According to an embodiment of the present invention, the preset offset index is 1. The intra prediction mode index corresponding to the basic angle mode to be replaced can be remapped to the wide angle mode to signal the corresponding wide angle mode. For example, the wide angle modes {−14, −13, . . . , −1} can be signaled by the intra prediction mode indices {52, 53, . . . , 66}, respectively, and the wide angle modes {67, 68, . . . , 80} can be signaled by the intra prediction mode indices {2, 3, . . . , 15}, respectively. In this way, the intra prediction mode index for the basic angle mode signals the extended angle mode, and thus the same set of intra prediction mode indices can be used for signaling the intra prediction mode even if the configuration of the angle modes used for intra prediction of each block are different from each other. Accordingly, signaling overhead due to a change in the intra prediction mode configuration can be minimized.

Meanwhile, whether or not to use the extended angle mode can be determined on the basis of at least one of the shape and size of the current block. According to an embodiment, when the size of the current block is greater than a preset size, the extended angle mode can be used for intra prediction of the current block, otherwise, only the basic angle mode can be used for intra prediction of the current block. According to another embodiment, when the current block is a block other than a square, the extended angle mode can be used for intra prediction of the current block, and when the current block is a square block, only the basic angle mode can be used for intra prediction of the current block.

The intra-prediction unit determines reference samples and/or interpolated reference samples to be used for intra prediction of the current block, based on the intra-prediction mode information of the current block. When the intra-prediction mode index indicates a specific angular mode, a reference sample corresponding to the specific angle or an interpolated reference sample from current samples in the current block is used for prediction of a current pixel. Thus, different sets of reference samples and/or interpolated reference samples may be used for intra prediction depending on the intra-prediction mode. After the intra prediction of the current block is performed using the reference samples and the intra-prediction mode information, the decoder reconstructs sample values of the current block by adding the residual signal of the current block, which has been obtained from the inverse transform unit, to the intra-prediction value of the current block.

Motion information used for inter prediction may include reference direction indication information (inter_pred_idc), reference picture index (ref_idx_10, ref_idx_11), and motion vector (mvL0, mvL1). Reference picture list utilization information (predFlagL0, predFlagL1) may be set based on the reference direction indication information. In one example, for a unidirectional prediction using an L0 reference picture, predFlagL0=1 and predFlagL1-0 may be set. For a unidirectional prediction using an L1 reference picture, predFlagL0-0 and predFlagL1=1 may be set. For bidirectional prediction using both the L0 and L1 reference pictures, predFlagL0=1 and predFlagL1=1 may be set.

When the current block is a coding unit, the coding unit may be partitioned into multiple sub-blocks, and the sub-blocks have the same prediction information or different pieces of prediction information. In one example, when the coding unit is in an intra mode, intra-prediction modes of the sub-blocks may be the same or different from each other. Also, when the coding unit is in an inter mode, the sub-blocks may have the same motion information or different pieces of motion information. Furthermore, the sub-blocks may be encoded or decoded independently of each other. Each sub-block may be distinguished by a sub-block index (sbIdx).

The motion vector of the current block is likely to be similar to the motion vector of a neighboring block. Therefore, the motion vector of the neighboring block may be used as a motion vector predictor (MVP), and the motion vector of the current block may be derived using the motion vector of the neighboring block. Furthermore, to improve the accuracy of the motion vector, the motion vector difference (MVD) between the optimal motion vector of the current block and the motion vector predictor found by the encoder from an original video may be signaled.

The motion vector may have various resolutions, and the resolution of the motion vector may vary on a block-by-block basis. The motion vector resolution may be expressed in integer units, half-pixel units, ¼ pixel units, 1/16 pixel units, 4-integer pixel units, etc. A video, such as screen content, has a simple graphical form such as text, and does not require an interpolation filter to be applied. Thus, integer units and 4-integer pixel units may be selectively applied on a block-by-block basis. A block encoded using an affine mode, which represent rotation and scale, exhibit significant changes in form, so integer units, ¼ pixel units, and 1/16 pixel units may be applied selectively on a block-by-block basis. Information about whether to selectively apply motion vector resolution on a block-by-block basis is signaled by amvr_flag. If applied, information about a motion vector resolution to be applied to the current block is signaled by amvr_precision_idx.

In the case of blocks to which bidirectional prediction is applied, weights applied between two prediction blocks may be equal or different, and information about the weights is signaled via BCW_IDX.

In order to improve the accuracy of the motion vector predictor, a merge or AMVP (advanced motion vector prediction) method may be selectively used on a block-by-block basis. The merge method is a method that configures motion information of a current block to be the same as motion information of a neighboring block adjacent to the current block, and is advantageous in that the motion information is spatially propagated without change in a motion region with homogeneity, and thus the encoding efficiency of the motion information is increased. On the other hand, the AMVP method is a method for predicting motion information in L0 and L1 prediction directions respectively and signaling the most optimal motion information in order to represent accurate motion information. The decoder derives motion information for a current block by using the AMVP or merge method, and then uses a reference block, located in the motion information in a reference picture, as a prediction block for the current block.

A method of deriving motion information in Merge or AMVP involves a method for constructing a motion candidate list using motion vector predictors derived from neighboring blocks of the current block, and then signaling index information for the optimal motion candidate. In the case of AMVP, motion candidate lists are derived for L0 and L1, respectively, so the most optimal motion candidate indexes (mvp_10_flag, mvp_11_flag) for L0 and L1 are signaled, respectively. In the case of Merge, a single move candidate list is derived, so a single merge index (merge_idx) is signaled. There may be various motion candidate lists derived from a single coding unit, and a motion candidate index or a merge index may be signaled for each motion candidate list. In this case, a mode in which there is no information about residual blocks in blocks encoded using the merge mode may be called a MergeSkip mode.

Symmetric MVD (SMVD) is a method which makes motion vector difference (MVD) values in the L0 and L1 directions symmetrical in the case of bi-directional prediction, thereby reducing the bit rate of motion information transmitted. The MVD information in the L1 direction that is symmetrical to the L0 direction is not transmitted, and reference picture information in the L0 and L1 directions is also not transmitted, but is derived during decoding.

Overlapped block motion compensation (OBMC) is a method in which, when blocks have different pieces of motion information, prediction blocks for a current block are generated by using motion information of neighboring blocks, and the prediction blocks are then weighted averaged to generate a final prediction block for the current block. This has the effect of reducing the blocking phenomenon that occurs at the block edges in a motion-compensated video.

Generally, a merged motion candidate has low motion accuracy. To improve the accuracy of the merge motion candidate, a merge mode with MVD (MMVD) method may be used. The MMVD method is a method for correcting motion information by using one candidate selected from several motion difference value candidates. Information about a correction value of the motion information obtained by the MMVD method (e.g., an index indicating one candidate selected from among the motion difference value candidates, etc.) may be included in a bitstream and transmitted to the decoder. By including the information about the correction value of the motion information in the bitstream, a bit rate may be saved compared to including an existing motion information difference value in a bitstream.

A template matching (TM) method is a method of configuring a template through a neighboring pixel of a current block, searching for a matching area most similar to the template, and correcting motion information. Template matching (TM) is a method of performing motion prediction by a decoder without including motion information in a bitstream so as to reduce the size of an encoded bitstream. The decoder does not have an original image, and thus may schematically derive motion information of a current block by using a pre-reconstructed neighboring block.

A Decoder-side Motion Vector Refinement (DMVR) method is a method for correcting motion information through the correlation of already reconstructed reference videos in order to find more accurate motion information. The DMVR method is a method which uses the bidirectional motion information of a current block to use, within predetermined regions of two reference pictures, a point with the best matching between reference blocks in the reference pictures as a new bidirectional motion. When the DMVR method is performed, the encoder may perform DMVR on one block to correct motion information, and then partition the block into sub-blocks and perform DMVR on each sub-block to correct motion information of the sub-block again, and this may be referred to as multi-pass DMVR (MP-DMVR).

A local illumination compensation (LIC) method is a method for compensating for changes in luma between blocks, and is a method which derives a linear model by using neighboring pixels adjacent to a current block, and then compensate for luma information of the current block by using the linear model.

Existing video encoding methods perform motion compensation by considering only parallel movements in upward, downward, leftward, and rightward directions, thus reducing the encoding efficiency when encoding videos that include movements such as zooming, scaling, and rotation that are commonly encountered in real life. To express the movements such as zooming, scaling, and rotation, affine model-based motion prediction techniques using four (rotation) or six (zooming, scaling, rotation) parameter models may be applied.

Bi-directional optical flow (BDOF) is used to correct a prediction block by estimating the amount of change in pixels on an optical-flow basis from a reference block of blocks with bi-directional motion. Motion information derived by the BDOF of VVC may be used to correct the motion of a current block.

Prediction refinement with optical flow (PROF) is a technique for improving the accuracy of affine motion prediction for each sub-block so as to be similar to the accuracy of motion prediction for each pixel. Similar to BDOF, PROF is a technique that obtains a final prediction signal by calculating a correction value for each pixel with respect to pixel values in which affine motion is compensated for each sub-block based on optical-flow.

The combined inter-/intra-picture prediction (CIIP) method is a method for generating a final prediction block by performing weighted averaging of a prediction block generated by an intra-picture prediction method and a prediction block generated by an inter-picture prediction method when generating a prediction block for the current block.

The intra block copy (IBC) method is a method for finding a part, which is most similar to a current block, in an already reconstructed region within a current picture and using the reference block as a prediction block for the current block. In this case, information related to a block vector, which is the distance between the current block and the reference block, may be included in a bitstream. The decoder can parse the information related to the block vector contained in the bitstream to calculate or set the block vector for the current block.

The bi-prediction with CU-level weights (BCW) method is a method in which with respect to two motion-compensated prediction blocks from different reference pictures, weighted averaging of the two prediction blocks is performed by adaptively applying weights on a block-by-block basis without generating the prediction blocks using an average.

The multi-hypothesis prediction (MHP) method is a method for performing weighted prediction through various prediction signals by transmitting additional motion information in addition to unidirectional and bidirectional motion information during inter-picture prediction.

A cross-component linear model (CCLM) is a method for configuring a linear model by using a high correlation between a luma signal and a chroma signal at the same location as the corresponding luma signal, and then predicting a chroma signal through the corresponding linear model. After a template is configured using a block completed to be reconstructed from among neighboring blocks adjacent to a current block, and then a parameter for the linear model is derived through the template. Next, a current luma block selectively reconstructed according to the size of the chroma block according to a video format is down-sampled. Lastly, a chroma component block of the current block is predicted using the down-sampled luma component block (sample) and the corresponding linear model. In this case, the method using two or more linear models is called a multi-model linear mode (MMLM).

A convolutional cross-component model (CCCM) is a method for configuring a non-linear model by using a high correlation between a luma signal and a chroma signal at the same location as the corresponding luma signal, and then predicting a chroma signal through the corresponding non-linear model.

A gradient linear model (GLM) is a method for configuring a model by additionally reflecting the gradient of a luma sample in a linear model such as the CCLM, and then predicting a chroma signal through the corresponding model. In independent scalar quantization, reconstructed coefficient t′ₖ for input coefficient tₖ is only dependent on quantization index qₖ. That is, a quantization index for any reconstructed coefficient has a value different from those of quantization indices for other reconstructed coefficients. In this case, t′ₖ may be a value obtained by adding a quantization error to tₖ, and may vary or remain the same according to a quantization parameter. Here, t′ₖ may be also referred to as a reconstructed transform coefficient or a de-quantized transform coefficient, and the quantization index may be also referred to as a quantized transform coefficient.

In uniform reconstruction quantization (URQ), reconstructed coefficients have the characteristic of being arrangement at equal intervals. The distance between two adjacent reconstructed values may be called a quantization step size. The reconstructed values may include 0, and the entire set of available reconstructed values may be uniquely defined based on the quantization step size. The quantization step size may vary depending on quantization parameters.

In the existing methods, quantization reduces the set of acceptable reconstructed transform coefficients, and elements of the set may be finite. Thus, there are limitation in minimizing the average error between an original video and a reconstructed video. Vector quantization may be used as a method for minimizing the average error.

A simple form of vector quantization used in video encoding is sign data hiding. This is a method in which the encoder does not encode a sign for one non-zero coefficient and the decoder determines the sign for the coefficient based on whether the sum of absolute values of all the coefficients is even or odd. To this end, in the encoder, at least one coefficient may be incremented or decremented by “1”, and the at least one coefficient may be selected and have a value adjusted so as to be optimal from the perspective of rate-distortion cost. In one example, a coefficient with a value close to the boundary between the quantization intervals may be selected.

Another vector quantization method is trellis-coded quantization, and, in video encoding, is used as an optimal path-searching technique to obtain optimized quantization values in dependent quantization. On a block-by-block basis, quantization candidates for all coefficients in a block are placed in a trellis graph, and the optimal trellis path between optimized quantization candidates is found by considering rate-distortion cost. Specifically, the dependent quantization applied to video encoding may be designed such that a set of acceptable reconstructed transform coefficients with respect to transform coefficients depends on the value of a transform coefficient that precedes a current transform coefficient in the reconstruction order. At this time, by selectively using multiple quantizers according to the transform coefficients, the average error between the original video and the reconstructed video is minimized, thereby increasing the encoding efficiency.

Among intra prediction encoding techniques, the matrix intra prediction (MIP) method is a matrix-based intra prediction method, and obtains a prediction signal by using a predefined matrix and offset values through pixels on the left and top of a neighboring block, unlike a prediction method having directionality from pixels of neighboring blocks adjacent to a current bloc.

To derive an intra-prediction mode for a current block, on the basis of a template which is a random reconstructed region adjacent to the current block, an intra-prediction mode for a template derived through neighboring pixels of the template may be used to reconstruct the current block. First, the decoder may generate a prediction template for the template by using neighboring pixels (references) adjacent to the template, and may use an intra-prediction mode, which has generated the most similar prediction template to an already reconstructed template, to reconstruct the current block. This method may be referred to as template intra mode derivation (TIMD).

In general, the encoder may determine a prediction mode for generating a prediction block and generate a bitstream including information about the determined prediction mode. The decoder may parse a received bitstream to set an intra-prediction mode. In this case, the bit rate of information about the prediction mode may be approximately 10% of the total bitstream size. To reduce the bit rate of information about the prediction mode, the encoder may not include information about an intra-prediction mode in the bitstream. Accordingly, the decoder may use the characteristics of neighboring blocks to derive (determine) an intra-prediction mode for reconstruction of a current block, and may use the derived intra-prediction mode to reconstruct the current block. In this case, to derive the intra-prediction mode, the decoder may apply a Sobel filter horizontally and vertically to each neighboring pixel adjacent to the current block to infer directional information, and then map the directional information to the intra-prediction mode. The method by which the decoder derives the intra-prediction mode using neighboring blocks may be described as decoder side intra mode derivation (DIMD).

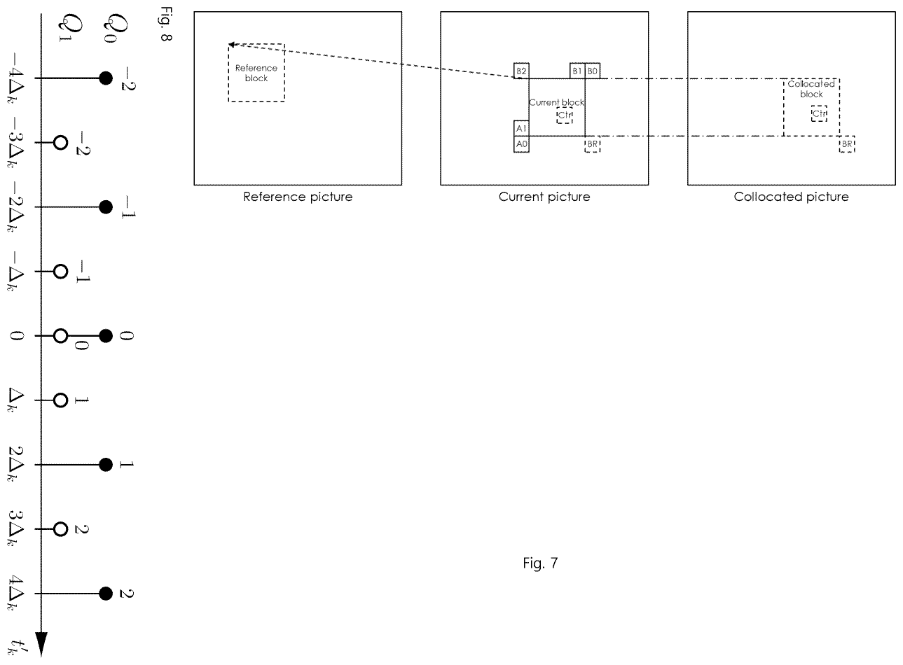

FIG. 7 illustrates the position of neighboring blocks used to construct a motion candidate list in inter prediction.

The neighboring blocks may be spatially located blocks or temporally located blocks. A neighboring block that is spatially adjacent to a current block may be at least one among a left (A1) block, a left below (A0) block, an above (B1) block, an above right (B0) block, or an above left (B2) block. A neighboring block that is temporally adjacent to the current block may be a block in a collocated picture, which includes the position of a top left pixel of a bottom right (BR) block of the current block. When a neighboring block temporally adjacent to the current block is encoded using an intra mode, or when the neighboring block temporally adjacent to the current block is positioned not to be used, a block, which includes a horizontal and vertical center (Ctr) pixel position in the current block, in the collocated picture corresponding to the current picture may be used as a temporal neighboring block. Motion candidate information derived from the collocated picture may be referred to as a temporal motion vector predictor (TMVP). Only one TMVP may be derived from one block. One block may be partitioned into multiple sub-blocks, and a TMVP candidate may be derived for each sub-block. A method for deriving TMVPs on a sub-block basis may be referred to as sub-block temporal motion vector predictor (sbTMVP).

Whether methods described in the present specification are to be applied may be determined on the basis of at least one of pieces of information relating to slice type information (e.g., whether a slice is an I slice, a P slice, or a B slice), whether the current block is a tile, whether the current block is a subpicture, the size of a current block, the depth of a coding unit, whether a current block is a luma block or a chroma block, whether a frame is a reference frame or a non-reference frame, and a temporal layer corresponding a reference sequence and a layer. Pieces of information used to determine whether methods described in the present specification are to be applied may be pieces of information promised between a decoder and an encoder in advance. In addition, such pieces of information may be determined according to a profile and a level. Such pieces of information may be expressed by a variable value, and a bitstream may include information on a variable value. That is, a decoder may parse information on a variable value included in a bitstream to determine whether the above methods are applied. For example, whether the above methods are to be applied may be determined on the basis of the width length or the height length of a coding unit. If the width length or the height length is equal to or greater than 32 (e.g., 32, 64, or 128), the above methods may be applied. If the width length or the height length is smaller than 32 (e.g., 2, 4, 8, or 16), the above methods may be applied. If the width length or the height length is equal to 4 or 8, the above methods may be applied.

FIG. 8 is a diagram illustrating two independent scalar quantizers according to an embodiment of the disclosure.

When a video signal processing device performs a dependent quantization method, two quantizers may be needed. The dependent quantization method of the video signal processing device may include a switching procedure between two quantizers. Referring to FIG. 8, two quantizers (Q₀, Q₁) may be defined to perform the dependent quantization method. In the case of regular restoration quantization, all reconstructed transform coefficients t′ₖ may be distributed at regular intervals based on an integer multiple of a quantization step size (Δₖ). t′ₖ may be a reconstructed transform coefficient or a dequantized transform coefficient. The quantizer Q₀ may include even-numbered multiples (e.g., −4Δₖ, −2Δₖ, 0, 2Δₖ, 4Δₖ and the like) of a quantization step size (Δk), and the quantizer Q₁ may include odd-numbered multiples (e.g., −3Δₖ, −Δₖ, 0, Δₖ, 3Δₖ and the like) of a quantization step size (Δk). Both the quantizers Q₀ and Q₁ may include reconstructed transform coefficients having values of ‘0’. A value marked above a circle that is the vertical coordinate in FIG. 8 denotes a quantization index (qₖ) associated with a reconstructed transform coefficient. A single quantization index (qₖ) may be mapped to one of the two reconstructed transform coefficients. For example, the quantization index (qₖ) −1 may be mapped to a reconstructed transform coefficient −2Δₖ of the quantizer Q₀, or a reconstructed transform coefficient −Δₖ of the quantizer Q₁. The quantizer index (qₖ) may be a quantized transform coefficient, an encoded transform coefficient, or a transform coefficient obtained by the video signal processing device via parsing a bitstream.

Unlike the existing independent scalar quantization, transform coefficients in a single block may be reconstructed according to a predetermined scan order. That is, the designated scan order may be a restoration order in which transform coefficients in a single block are reconstructed. In this instance, the restoration order may be the same as a quantization index (qₖ) encoding or decoding order. In consideration of the designated restoration order, the switching procedure between two quantizers may be described based on a 2^{N} state (state, N>=2) switching model. The video signal processing device may determine a quantizer to be used for the dependent quantization method based on the state sₖ of a transform coefficient tₖ which is the current target of restoration. The state sₖ₊₁ of a coefficient tₖ₊₁ to be reconstructed subsequently to tₖ may be determined based on a parity pₖ calculated based on the current quantization index qₖ and the current state sₖ. pₖ may be the result value of qₖ & 1. That is, pₖ=qₖ & 1. & in the disclosure denotes a bit operator AND. When both the left operand and the right operand are odd numbers, 1 is output. When any one of the left operand and the right operand is an even number, 0 is output. That is, when qₖ is 1, pₖ is 1, and when qₖ is 0, pₖ is 0.

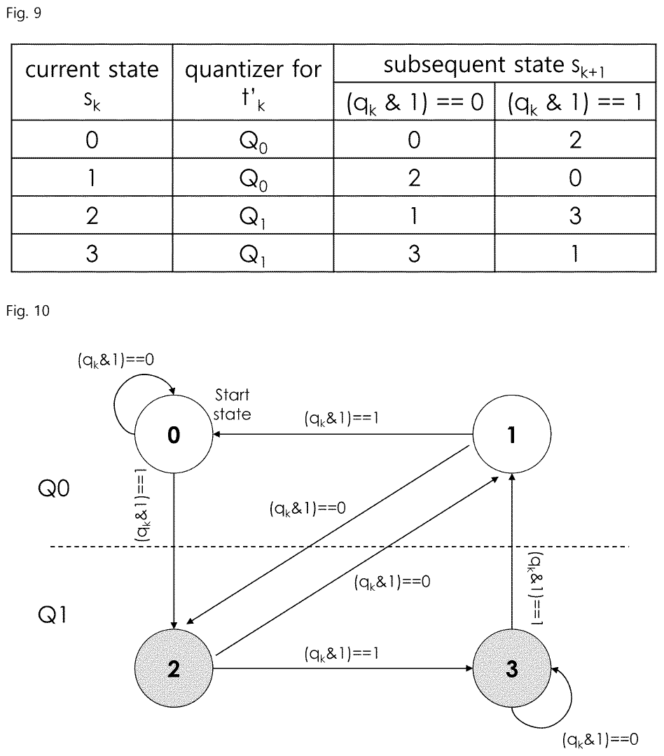

FIG. 9 is a diagram illustrating a state transition table according to an embodiment of the disclosure.

FIG. 9 illustrates a quantizer selected based on a current state, and a subsequent state transitioned from the current state. Referring to FIG. 9, a video signal processing device may select a quantizer based on the current state, and a subsequent state may be determined based on a quantization index qₖ. For example, in the case in which the current state is 0, the video signal processing device may select quantizer Q₀. In this instance, when the quantization index qₖ is an even number, the subsequent state may be 0. When the quantization index qₖ is an odd number, the subsequent state may be 2. When the current state is 1, the video signal processing device may select the quantizer Q₀. In this instance, when the quantization index qₖ is an even number, the subsequent state may be 2. When the quantization index qₖ is an odd number, the subsequent state may be 0. When the current state is 2, the video signal processing device may select the quantizer Q₁. In this instance, when the quantization index qₖ is an even number, the subsequent state may be 1. When the quantization index qₖ is an odd number, the subsequent state may be 3. When the current state is 3, the video signal processing device may select the quantizer Q₁. In this instance, when the quantization index q is an even number, the subsequent state may be 3. When the quantization index qₖ is an odd number, the subsequent state may be 1. When dependent quantization is initially performed, the initial value of a state may be configured to 0.

FIG. 10 is a state transition graph according to an embodiment of the disclosure.

FIG. 10 is a diagram illustrating the state transition table of FIG. 9 in the form of a graph. The number (0, 1, 2, 3) in a circle of FIG. 10 may indicate a current state. The state sₖ₊₁ of a coefficient tₖ₊₁ to be reconstructed subsequently to tₖ may be determined based on a parity pₖ calculated based on a current quantization index qₖ and the current state sₖ. Referring to FIG. 10, when the current state is 0 or 1, a video signal processing device may select quantizer Q₀, and when the current state is 2 or 3, the video signal processing device may select quantizer Q₁.

sₖ₊₁ may be expressed as given in Table 1.

TABLE 1

QStateTransTable[ ][ ] = { { 0, 2 }, { 2, 0 }, { 1, 3 }, { 3, 1 } }

{0, 2} may denote subsequent state candidates available when the current state sₖ of FIG. 9 and FIG. 10 is 0. {2, 0} may denote subsequent state candidates available when the current state sₖ of FIG. 9 and FIG. 10 is 1. {1, 3} may denote subsequent state candidates available when the current state sₖ of FIG. 9 and FIG. 10 is 2. {3, 1} may denote subsequent state candidates available when the current state sₖ of FIG. 9 and FIG. 10 is 3. The subsequent state candidates {x, y} in Table 1 may be {the case in which a quantization index is an even number, the case in which a quantization index is an odd number}.

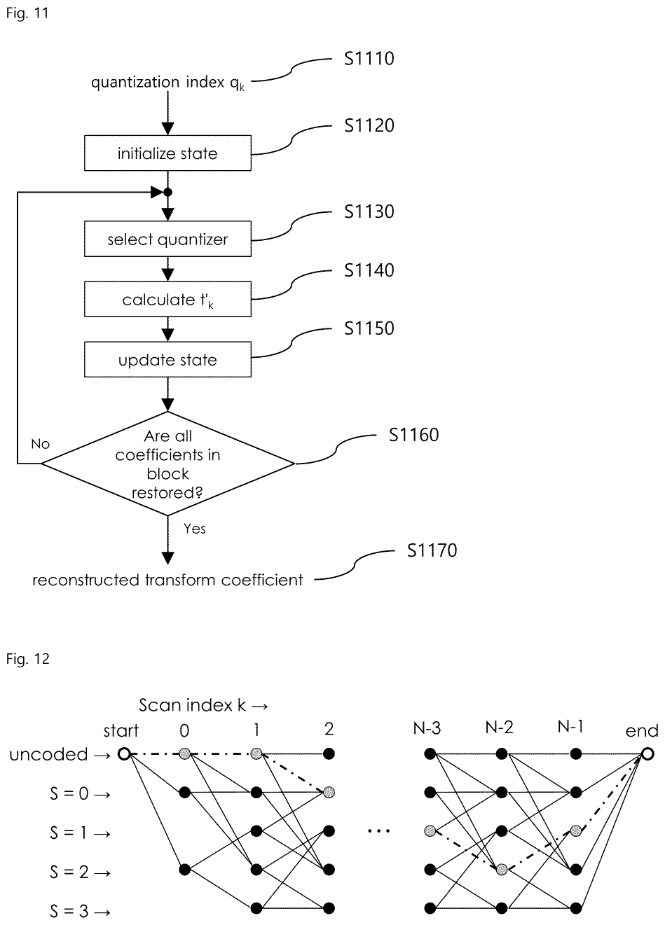

FIG. 11 is a diagram illustrating a process of restoring a transform coefficient according to an embodiment of the disclosure.

Hereinafter, a process of restoring a transform coefficient will be described with reference to FIG. 11.

A video signal processing device may obtain a quantization index qₖ in operation S1110. The video signal processing device may initialize a current state sₖ to 0 in operation S1120. The video signal processing device may select a quantizer based on the current state sₖ in operation S1130. For example, the video signal processing device may select quantizer Q₀ when the result value of sₖ>>1 is 0, and the video signal processing device may select quantizer Q₁ when the result value of sₖ>>1 is 1. ‘>>’ is a bit shift operator that outputs a value obtained by repeatedly performing division by 2 as a number of times as the a number on the right side. The video signal processing device may calculate t′k by using the selected quantizer in operation S1140. Operation S1140 may be performed via two steps. Initially, the video signal processing device may calculate a quantization index qₖ by an integer factor, so as to obtain q′ₖ for a quantization step size Δk. In this instance, an integer number may be a value greater than or equal to 2, and may be a multiple of 2. For example, q′ₖ may be a value obtained via subtraction between a product of qₖ and 2 (an integer number) and a product of the result value of (sₖ>>1) and a sign of qₖ. Subsequently, the video signal processing device may use a regular restoration quantization, and may obtain t′k by multiplying q′k and Δk. The video signal processing device may use sₖ and qₖ, so as to update a state (sₖ₊₁) for a transform coefficient to be subsequently reconstructed in operation S1150. In this instance, the state (sₖ₊₁) for the transform coefficient to be subsequently reconstructed may be updated according to the description provided with reference to FIGS. 9 and 10. The video signal processing device may identify whether all coefficients in a block are reconstructed in operation S1160. In the case in which not all the coefficients in the block are reconstructed, the video signal processing device may proceed with operations S1130 and S1150, so as to reconstruct the transform coefficient (tₖ₊₁) to be subsequently reconstructed. In the case in which all the coefficients in the block are reconstructed, the video signal processing device may output all the reconstructed transform coefficients (t′ₖ) in the block in operation S1170. That is, the video signal processing device may reconstruct transform coefficients corresponding to all quantization indices in the current block. In this instance, a restoration order used for restoration of transform coefficients may be a predetermined restoration order.

FIG. 12 is a diagram illustrating an optimal trellis path according to an embodiment of the disclosure.

For quantization, quantization candidates for all coefficients in a block may be disposed in a trellis graph. For optimal quantization, an optimal trellis path may be needed. In this instance, a Viterbi algorithm may be used as a method of searching for an optimal trellis path. The Viterbi algorithm may be a scheme of searching for an optimal trellis path among optimized quantization candidates in consideration of rate-distortion costs. FIG. 12 is an optimal trellis path obtained via the Viterbi algorithm. An encoder may take into consideration an ‘uncoded’ state in addition to the four states that have been described with reference to FIGS. 9 and 10. The ‘uncoded’ state may be used for a transform coefficient that is reconstructed before restoration of a first transform coefficient different from 0 among transform coefficients that are recorded in a restoration order. Referring to FIG. 12, the first transform coefficient different from 0 may be a transform coefficient having a scan index of 2. A previous transform coefficient (a scan index of 0 and a scan index of 1) of the first transform coefficient different from 0 may be configured to an ‘uncoded’ state so as not to affect state transition. The path marked with a broken line in FIG. 12 may be an optimal trellis path that an encoder searches for. S in FIG. 12 denotes a state. Information associated with a first transform coefficient different from 0 may be included in a bitstream generated by the encoder.

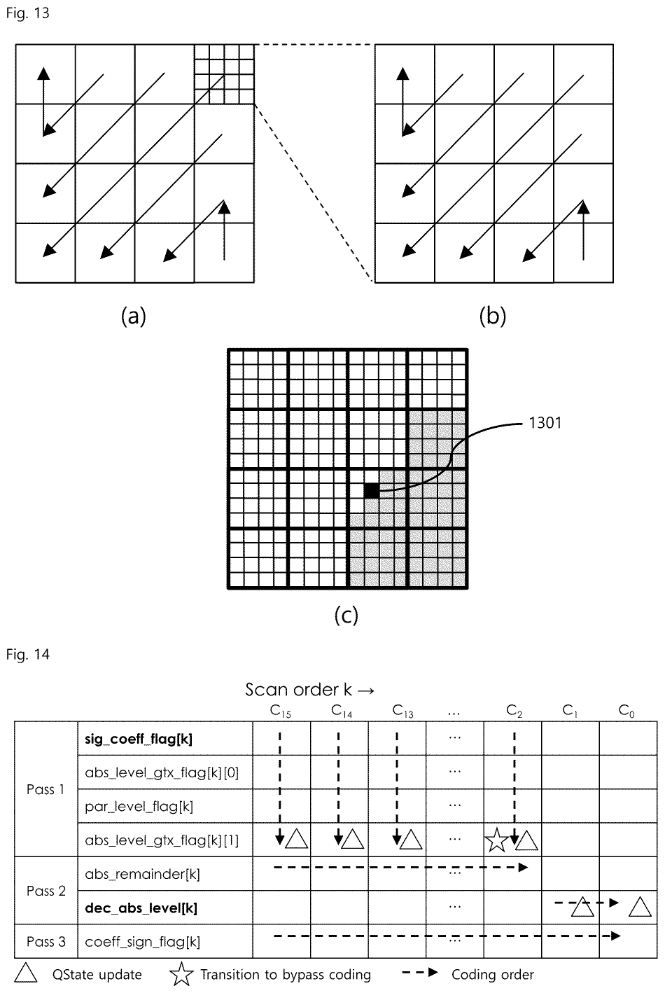

FIG. 13 is a diagram illustrating a restoration order for transform coefficients according to an embodiment of the disclosure.

Referring to FIG. 13, a current block may be a 16×16 sized block, and arrows in FIG. 13A and FIG. 13B refer to an order (direction) in which a decoder reconstructs transform coefficients for a current block. The restoration order of transform coefficients may be an order in which an encoder performs encoding. The restoration order described in FIG. 13 may be a predetermined restoration order that has been described in the disclosure. FIG. 13A illustrates a restoration order of subblocks when the current block is divided into 4×4 sized subblocks. FIG. 13B illustrates a restoration order of coefficients in a single subblock obtained via division. The restoration order described in FIG. 13A and FIG. 13B may refer to a diagonal scan order. FIG. 13C illustrates an uncoded area and the location of a first transform coefficient different from 0. The grey area in FIG. 13C may be an area in which transform coefficients are uncoded. In the case in which the entire part of a subblock is colored with grey, this indicates that all coefficients of the corresponding subblock are uncoded. In addition, a part 1301 colored with black refers to the location of a first transform coefficient different from 0. That is, referring to FIG. 13C, coefficients located ahead of the first transform coefficient different from 0 in the restoration order are not encoded (since a transform coefficient is 0), and thus they are expressed as a grey area.

FIG. 14 is a diagram illustrating a method of updating the states of transform coefficients and syntax elements according to an embodiment of the disclosure.

FIG. 14 is a diagram illustrating syntax elements related to transform coefficients in a single subblock that are parsed according to a restoration order, and an update order for the states of the transform coefficients. There may be two methods of parsing an absolute value for a single coefficient. For example, according to a first method, a video signal processing device parses multiple syntax elements, and obtains a final coefficient via combining the corresponding syntaxes. According to a second method, the video signal processing device obtains a final coefficient using a single syntax element. The first method may have a high encoding efficiency but have a drawback of a low parsing processing speed due to a process of inducing and updating a context model for parsing. Conversely, the second method has a high processing speed but has a drawback of a low encoding efficiency. To overcome the drawbacks, the first method and the second method may be used together. The maximum number of bins allowed in the current block may be limited. For example, the video signal processing device may use the first method in the case in which the number of currently used bins is less than or equal to a threshold value, and may use the second method in the case in which the number of currently used bins is greater than the threshold. Here, the threshold value may be a value determined based on the width and length of the current block.

Hereinafter, provided is a description of a method of parsing syntax elements related to coefficients in a subblock. In this instance, the syntax elements related to the coefficient in the subblock may be parsed according to a restoration order (scan order) which has been described with reference to FIG. 13. Cₖ in FIG. 14 denotes indices of coefficients of a subblock in the current block. Referring to FIG. 13, a subblock may be a 4×4 sized block and include 16 coefficients. In this instance, the coefficients of a subblock may be indexed. k is an index related to a restoration order. The index of a coefficient that is to be reconstructed first in the restoration order (scan order) is C₁₅, the index of a coefficient to be subsequently reconstructed is C₁₄, the index of a coefficient to be subsequently reconstructed is C₁₃, . . . , and the index of a coefficient to be reconstructed last is C₀.

First, the video signal processing device may perform process ‘Pass 1’ in FIG. 14 (the first method that parses multiple syntax elements and obtains a final coefficient via combination of the corresponding syntaxes). Specifically, the video signal processing device parse syntax elements (sig_coeff_flag[k], abs_level_gtx_flag[k][0], par_level_flag[k], abs_level_gtx_flag[k][1]) for the process ‘Pass 1’, and may parse coefficients in a subblock according to a restoration order. The video signal processing device may parse syntax elements (sig_coeff_flag[k], abs_level_gtx_flag[k][0], par_level_flag[k], abs_level_gtx_flag[k][1]) related to coefficients in a subblock, and may obtain a quantization index. In this instance, a current state sₖ may be used to induce a context model for sig_coeff_flag[k]. The video signal processing device may identify a parity for a current quantization index based on a result obtained by parsing the syntax elements of the process ‘Pass 1’. Based on the parity for the current quantization index, the video signal processing device may update a state to be used for parsing a syntax element sig_coeff_flag[k] of a coefficient to be subsequently reconstructed. The video signal processing device may identify whether the number of currently used bins is greater than a threshold value. In this instance, in the case in which the number of currently used bins is greater than the threshold value, the video signal processing device may terminate the process ‘Pass 1’, and may perform process ‘Pass 2’. In the case in which the number of currently used bins is less than or equal to the threshold value, the process ‘Pass 1’ for a coefficient to be subsequently reconstructed may be performed according to a restoration order. Referring to FIG. 14, in the case in which syntax elements for the process ‘Pass 1’ of C₂ are parsed, the number of currently used bins may be higher than a threshold value. A method (the second method) of parsing a single syntax element may be used for restoring coefficients (C₁, C₀) to be subsequently reconstructed in the restoration order. In this instance, a single syntax element for restoration of C₁ and C₀ may be parsed in a bypass mode without using a context model.

Subsequently, the video signal processing device may perform the process ‘Pass 2’ (the second method that obtains a final coefficient using a single syntax element). The video signal processing device may parse a remaining syntax element abs_remainder[k] for coefficients reconstructed in the ‘Pass 1’ process. In this instance, abs_remainder[k] may be parsed up to a point where as many bins as a number smaller than or equal to the threshold value of the process ‘Pass 1’ are used. Referring to FIG. 14, the video signal processing device may only parse abs_remainder[k] from Cis to C₂. In this instance, abs_remainder[k] may be parsed in a bypass mode without using a context model. After parsing abs_remainder[k], the video signal processing device may parse a syntax element dec_abs_level[k] related to coefficients for which bins of which the number is greater than the threshold value are used. In this instance, dec_abs_level[k] may be parsed in a bypass mode without using a context model. For binarization of dec_abs_level[k], the current state sₖ may be used. Based on a result obtained by parsing dec_abs_level[k], the video signal processing device may identify a parity for a current coefficient. Based on the parity for the current coefficient, the video signal processing device may update a state used for a coefficient to be subsequently reconstructed. The video signal processing device may parse coeff_sign_flag and may obtain information associated with a coefficient sign. The video signal processing device may parse coeff_sign_flag related to all coefficients of which the value of sig_coeff_flag is 1 in a subblock.

sig_coeff_flag[k] of FIG. 14 may be a syntax element that indicates whether a k^{th} coefficient in the restoration order is a coefficient different from 0. For example, in the case in which the value of sig_coeff_flag[k] is 1, this indicates that the k^{th} coefficient is a coefficient different from 0. abs_level_gtx_flag[k][0] may be a syntax element indicating whether the k^{th} coefficient in the restoration order is greater than 1. In the case in which the value of abs_level_gtx_flag[k][0] is 1, this indicates that the k^{th} coefficient is greater than 1. par_level_flag[k] may be a syntax element indicating a parity of the k^{th} coefficient. In the case in which the value of par_level_flag[k] is 1, this indicates that k^{th} coefficient is an odd number. abs_level_gtx_flag[k][1] may be a syntax element indicating whether the k^{th} coefficient in the restoration order is greater than 3. In the case in which the value of abs_level_gtx_flag[k][1] is 1, this indicates that the k^{th} coefficient is greater than 3. abs_remainder[k] may be a syntax element indicating the magnitude of a remaining absolute value of the k^{th} coefficient in the restoration order. dec_abs_level[k] may be a syntax element indicating the magnitude of an absolute value of the k^{th} coefficient in the restoration order. coeff_sign_flag[k] may be a syntax element indicating the sign (+, −) of the k^{th} coefficient in the restoration order.

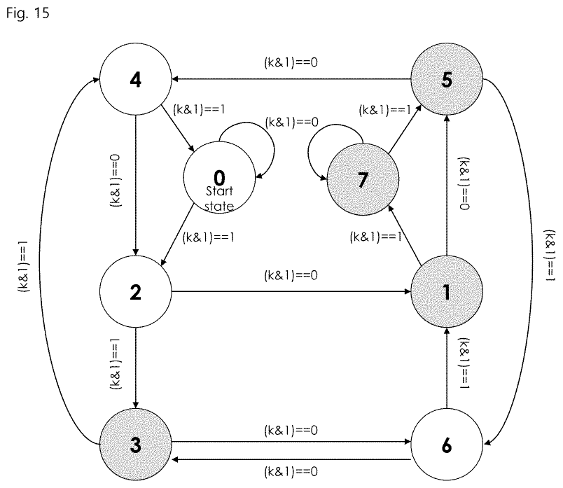

FIGS. 15 to 17 are state transition graphs according to an embodiment of the disclosure.

For a dependent quantization method described in the disclosure, a process of searching for an optimal trellis path among optimized quantization candidates via four states may be needed. To search for an optimal trellis path, a trellis path may be diversified by expanding a current state to 8 states. FIG. 15 is a diagram illustrating a transition procedure for 8 states. k in FIG. 15 may be a quantization index qₖ. The transition procedure of FIG. 15 is configured so that the same quantizer is used for a subsequent state, when a current state is transitioned to a subsequent state. That is, the configuration is performed so that a quantizer (Q₀, Q₁) is not selected depending on the parity of a k value in the current state, and a predetermined quantizer is used. For example, when the current state is 0, the subsequent state may be 0 or 2. In this instance, the state of 0 or 2 may use the same quantizer Q₀. In the same manner, when the current state is 1, the subsequent state may be 5 or 7. In this instance, the state of 5 or 7 may use the same quantizer Q₁. In other words, a state is transitioned to a subsequent state according to a k value, but all the available candidates of the subsequent states use the same quantizer.

A subsequent state sₖ₊₁ for state transition of FIG. 15 may be expressed as shown in Table 2.

TABLE 2

QStateTransTable[ ][ ] = { { 0, 2 }, { 5, 7 }, { 1, 3 },
{ 6, 4 }, { 2, 0 }, { 4, 6 }, { 3, 1 }, { 7, 5 } }

{0, 2} may denote subsequent state candidates available when the current state sₖ is 0. {5, 7} may denote subsequent state candidates available when the current state sₖ is 1. {1, 3} may denote subsequent state candidates available when the current state sₖ is 2. {6, 4} may denote subsequent state candidates available when the current state sₖ is 3. {2, 0} may denote subsequent state candidates available when the current state sₖ is 4. {4, 6} may denote subsequent state candidates available when the current state sₖ is 5. {3, 1} may denote subsequent state candidates available when the current state sₖ is 6. {7, 5} may denote subsequent state candidates available when the current state sₖ is 7. The subsequent state candidates {x, y} in Table 2 may be {the case in which a quantization index is an even number, the case in which a quantization index is an odd number}. As described above, the available subsequent state candidates {x, y} in Table 2 may use the same quantizer.

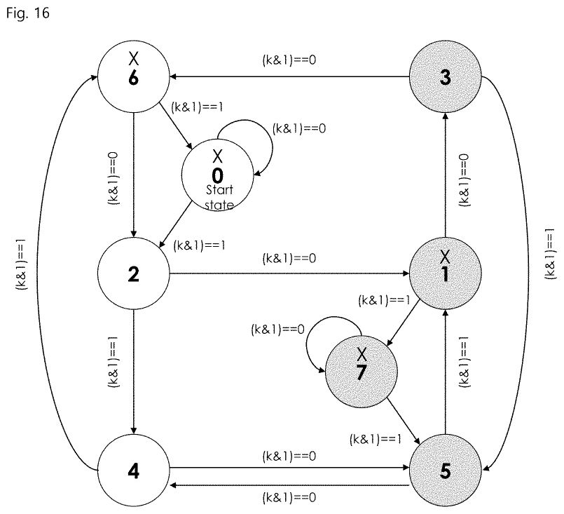

A transition procedure for a video signal processing device to flexibly select a quantizer may be needed. Referring to FIG. 16, an encoder may select a quantizer to be used for a subsequent state depending on the parity of a k value, or may select a predetermined quantizer, irrespective of a k value. For example, referring to FIG. 16, in the case in which a current state is 0, 1, 6, or 7 (a state marked with X), a predetermined quantizer may be used for a subsequent state, irrespective of the parity of a k value. However, in the case in which the current state is 2, 3, 4, or 5 (a state not marked with X), quantizers Q₀ and Q₁ may be selectively used for a subsequent state, depending on the parity of a k value. That is, whether a predetermined quantizer is to be used or a quantizer is to be selected for use based on the parity of a k value may be determined based on current state information.

A subsequent state sₖ₊₁ for state transition of FIG. 16 may be expressed as shown in Table 3.

TABLE 3
QStateTransTable[ ][ ] = { { 0, 2 }, { 3, 7 }, { 1, 4 }, { 6, 5 }, { 5, 6 },
{ 4, 1 }, { 2, 0 }, { 7, 5 } }

{0, 2} may denote subsequent state candidates available when the current state sₖ is 0. {3, 7} may denote subsequent state candidates available when the current state sₖ is 1. {1, 4} may denote subsequent state candidates available when the current state sₖ is 2. {6, 5} may denote subsequent state candidates available when the current state sₖ is 3. {5, 6} may denote subsequent state candidates available when the current state sₖ is 4. {4, 1} may denote subsequent state candidates available when the current state sₖ is 5. {2, 0} may denote subsequent state candidates available when the current state sₖ is 6. {7, 5} may denote subsequent state candidates available when the current state sₖ is 7. The subsequent state {x, y} in Table 3 may be {the case in which a quantization index is an even number, the case in which a quantization index is an odd number}. Referring to FIG. 16 and Table 3, in the case in which the current state is 0, 1, 6, or 7, the subsequent state {x, y} may use the same quantizer. In the case in which the current state is 2, 3, 4, or 5, the subsequent state {x, y} may use different quantizers.

When a trellis path is diversified by expanding the current state to 8 states, complexity may be increased, which is a drawback. Hereinafter, a method of overcoming complexity will be described.

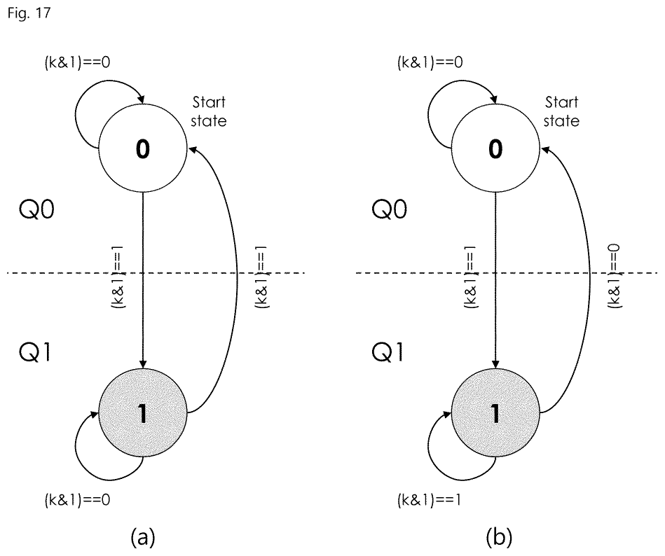

As described in FIG. 17, complexity may be mitigated by using only two states. A transition procedure may be variously changed based on the parity of a k value. Referring to FIG. 17A, in the case in which the parity of a k value is 0, a state itself (a current state) is selected as a subsequent state. In the case in which the parity of the k value is 1, a different state may be selected as a subsequent state. In FIG. 17B, a transition procedure same as FIG. 17A is used in the case in which a current state is 0. In the case in which the current state is 1, a state different from the current state is selected as a subsequent state when the parity of a k value is 0, and the state itself (the current state) is selected as a subsequent state when the parity of the k value is 1. That is, depending on the parity of the k value, various transition procedures may be used.

A subsequent state sₖ₊₁ for state transition of FIG. 17A may be expressed as shown in Table 4, and a subsequent state sₖ₊₁ for state transition of FIG. 17B may be expressed as shown in Table 5.

TABLE 4

QStateTransTable[ ][ ] = { { 0, 1 }, { 1, 0 } }

TABLE 5

QStateTransTable[ ][ ] = { { 0, 1 }, { 0, 1 } }

Referring to Table 4, {0, 1} may denote subsequent state candidates available when the current state sₖ is 0. {1, 0} may denote subsequent state candidates available when the current state sₖ is 1.

Referring to Table 5, {0, 1} may denote subsequent state candidates available when the current state sₖ is 0. {0, 1} may denote subsequent state candidates available when the current state sₖ is 1. The subsequent state {x, y} in Table 4 and Table 5 may be {the case in which a quantization index is an even number, the case in which a quantization index is an odd number}.

An encoder may obtain a bitstream including information indicating a transition procedure used among the various transition procedures. In this instance, information indicating a transition procedure used may be signaled on at least one level among bitstream's SPS, PPS, picture header, slice header, tile, and CU. A decoder may parse information that indicates a transition procedure used and is included a bitstream, and may configure a transition procedure to be used in a unit of a SPS, PPS, picture header, slice header, tile, or CU.

When a current block is encoded at a low bit rate, there may be numerous cases in which quantized transform coefficients in the current block are 0. In the case in which a coefficient of 0 is successively repeated, this may not highly affect the decoder since only a transition procedure is performed in the decoder. However, in the encoder, costs for a quantized coefficient of 0 need to be calculated and a search for an optimal path needs to be performed, and thus complexity and memory may be unnecessarily increased, which is a drawback. To decrease the unnecessary complexity of the encoder, a transition procedure that is separate with respect to a coefficient of 0 may be used. Hereinafter, a separate transition procedure will be described.

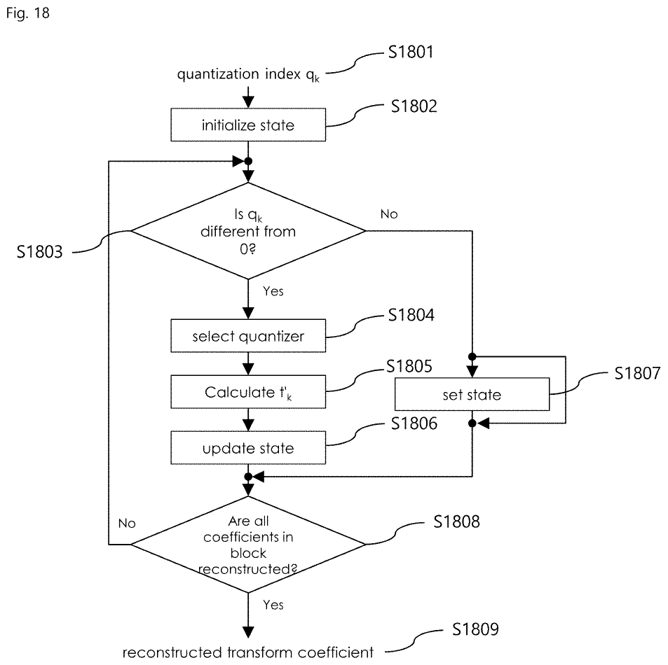

FIG. 18 is a diagram illustrating a separate transition procedure according to an embodiment of the present disclosure.

A video signal processing device may obtain a current quantization index qₖ in operation S1801. The video signal processing device may initialize a current state in operation S1802. In this instance, the initialized current state may be 0. The video signal processing device may determine whether the current quantization index qₖ is 0 in operation S1803. In this instance, in the case in which qₖ is different from 0, the video signal processing device may perform a transition procedure that has been described with reference to FIG. 8 to FIG. 17. That is, the video signal processing device may select a quantizer based on the current state sₖ, may calculate a transform coefficient t′ₖ using the selected quantizer, and may update the current state in operations S1804 to S1806. In the case in which qₖ is 0, the video signal processing device may not proceed with operations S1804 to S1806, but may configure only the current state in operation S1807. The current state of operation S1807 may be configured to a predetermined state, for example, 0. The video signal processing device may determine whether all coefficients in the current block are reconstructed in operation S1808. In the case in which all the coefficients are reconstructed, the video signal processing device may output all the reconstructed transform coefficients (t′ₖ) in the current block in operation S1809. In the case in which not all coefficients are reconstructed, the video signal processing device may perform operation S1803 again with respect to a coefficient to be subsequently reconstructed.

In the case in which qₖ is 0, the video signal processing device may not reconfigure the current state, but maintain a previously configured state, as it is. That is, a state that has been configured by a quantization index different from 0 may be used, as it is, as a state for a subsequent quantization index different from 0.

In the case in which a quantization index is 0, a transform coefficient may be reconstructed using a transition procedure that has been described with reference to FIGS. 8 to 17. In the case in which N consecutive quantization indices of 0 are present, a predetermined state may be configured as a current state. Here, N may be an integer number greater than or equal to 2.

In the case in which the number of states for a dependent quantization method is increased, encoding efficiency may be increased and complexity may also be increased. That is, the encoding efficiency and complexity may be in a trade-off relationship. Hereinafter, a method of configuring the number of states in a video signal processing device will be described.

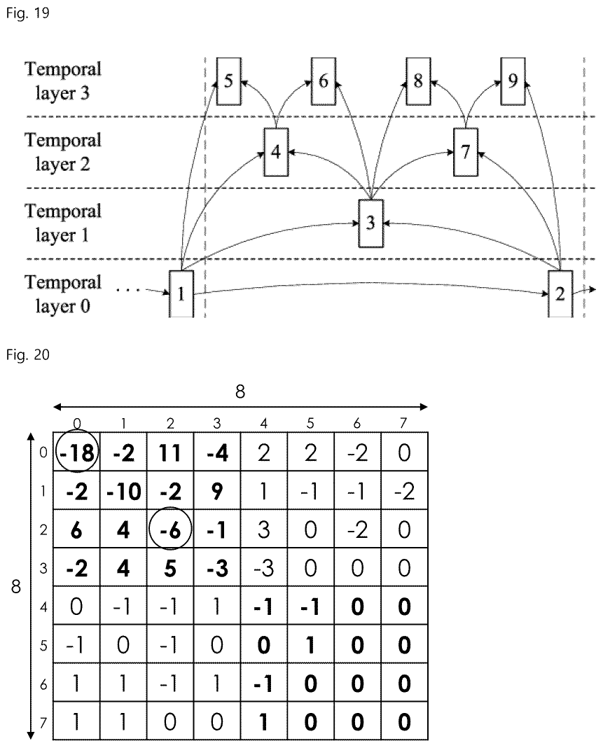

FIG. 19 is a diagram illustrating a method of configuring the number of states based on a temporal layer according to an embodiment of the disclosure.

A temporal layer is used to hierarchically support an image from a low frame rate to a high frame rate, and a temporal resolution of an image, that is, a frame rate of an image, may be increased as a temporal layer is higher. The number of states may be configured based on a temporal layer number. As a temporal layer number is higher, a higher quantization parameter is used, and thus the amount of residual signals may be low. In a temporal layer with a high number, a larger number of coefficients may have values close to 0 and a smaller number of coefficients may be encoded, when compared to the coefficients in a temporal layer with a low number. Therefore, as a temporal layer number is increased, the number of states may be decreased. For example, in the case in which a temporal layer number is 0, the number of states may be 8. In the case in which a temporal layer number is 1 or 2, the number of states may be 4. In the case in which a temporal layer number is 3, the number of states may be 2. Conversely, as a temporal layer number is increased, the number of states may also be increased.

The number of states may be configured based on a quantization parameter. For example, in the case in which a quantization parameter is less than or equal to 22, the number of states may be 8. In the case in which a quantization parameter is greater than 22 and less than or equal to 32, the number of states may be 4. In the case in which a quantization parameter is greater than 32, the number of states may be 2.

The number of states may be configured based on whether the components of a current block correspond to a brightness block or a chrominance block. For example, in the case in which the current block is a brightness block, the number of states may be 8. In the case in which the current block is a chrominance block, the number of states may be 2 or 4.

The number of states may be configured based on a syntax element. That is, when a syntax element for the ‘Pass 1’ process of FIG. 14 is parsed, a small number of states may be configured. When a syntax element for the ‘Pass 2’ process is parsed, a large number of states may be configured. For example, the number of states used for inducing a context model for sig_coeff_flag[k] may be 4, and state updating may be performed using 4 states in the case of ‘abs_level_gtx_flag[k][0]’, par_level_flag[k], ‘abs_level_gtx_flag[k][1]’. State updating may be performed using 8 states in the case of ‘dec_abs_level[k]’. Conversely, when a syntax element for the ‘Pass 1’ process of FIG. 14 is parsed, the number of states may be configured to 8. When a syntax element for the ‘Pass 2’ process is parsed, the number of states may be configured to 4.

FIG. 20 is a diagram illustrating a quantization index for an 8×8 sized block according to an embodiment of the disclosure.

Referring to FIG. 20, a quantization index qₖ has a feature of being increased from the bottom-right end to the top-left end. A video signal processing device may perform a process of configuring a state using a quantization index, and selecting a quantizer according to a restoration order (the restoration order (scan order) of FIG. 13). Referring to FIG. 20, a current block may be divided into four 4×4 subblocks, and restoration may be performed for each subblock. In this instance, state information continues between the subblocks and the last state information of a previous subblock may be continuously used, as it is, for a subsequent subblock. Depending on the location of a subblock, the range of a magnitude of a quantization index may vary. Therefore, the video signal processing device may perform dependent quantization by configuring the number of states differently based on the location of a subblock.

The video signal processing device may use 8 states when performing dependent quantization for the top-left subblock. In the case of the top-left subblock, the range of a magnitude of a quantization index is wide. The video signal processing device may use 2 states when performing dependent quantization for the bottom-right subblock. In the case of the bottom-right subblock, the magnitude of a quantization index is small and the range thereof is also narrow. The video signal processing device may use 4 states when performing dependent quantization for the remaining subblocks excluding the top-left subblock and the bottom-right subblock.

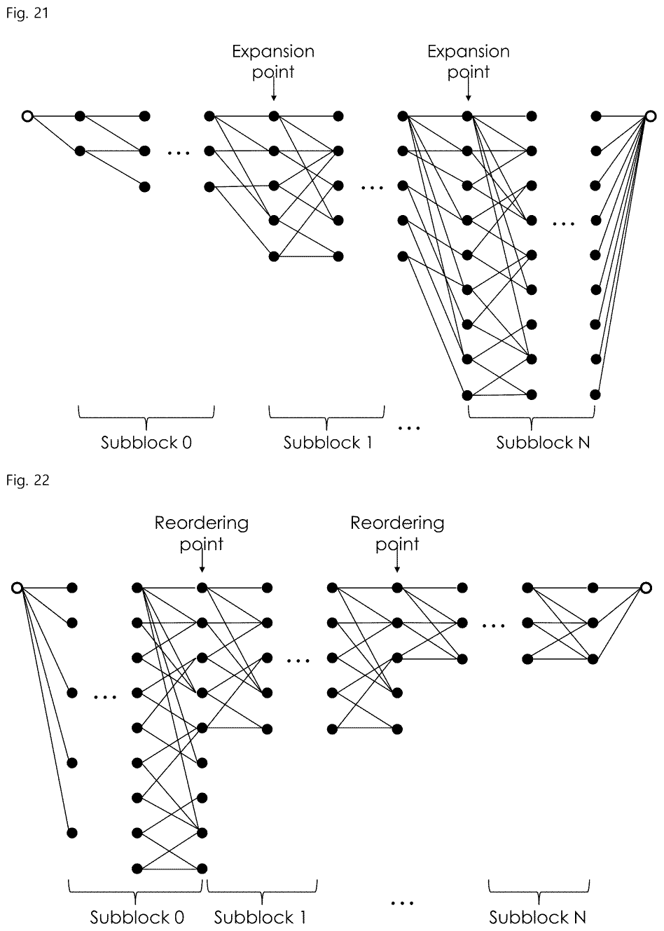

FIG. 21 and FIG. 22 are diagrams illustrating a method of changing the number of states according to an embodiment of the disclosure.

FIG. 21 is a diagram illustrating a method of expanding the number of states according to an embodiment of the disclosure. The number of states is different for each subblock, and thus the number of states may be expandable when state transition is performed from one subblock to another subblock. A state transition point at which the number of states is expanded may be referred to as an expansion point. Referring to FIG. 21, when state transition is performed from one subblock (e.g., subblock 0 of FIG. 21) to another subblock (e.g., subblock 1 of FIG. 21), the number of states may be expanded from 2 to 4. According to the method of expanding the number of states, 8 states are not initially used due to causing complexity, and thus complexity may be decreased from the perspective of an encoder.

FIG. 22 is a diagram illustrating a method of reducing the number of states according to an embodiment of the disclosure. The number of states may be reducible when state transition is performed from one subblock to another subblock. A state transition point at which the number of states is reduced may be referred to as a reduction point. Referring to FIG. 22, when state transition is performed from one subblock (e.g., subblock 0 of FIG. 22) to another subblock (e.g., subblock 1 of FIG. 22), the number of states may be reduced from 8 to 4. A video signal processing device may perform reordering based on costs at a reduction point. The method of reducing the number of states may eliminate a path, which is beyond capability, early, and thus may reduce complexity.

In addition, the number of states may be configured based on the locations of the low and column of a coefficient. That is, the location of the row and column of a coefficient may be expressed in the form of coordinates (row, column). In the case in which the location of a coefficient is (i, j), the number of states may be configured to x. For example, the number of states may be 8 when the location of a coefficient is (0, 0), (1, 0), (0, 1), or (1, 1), and the number of states may be 4 for the remaining locations.

An encoder may generate a bitstream including information associated with the number of states applied to each subblock. A decoder may parse information associated with the number of states included in a bitstream, may determine the number of states applied to a corresponding subblock, and may perform dependent quantization based on the determined number of states.

The dependent quantization method may show a high encoding efficiency but has a drawback in that the complexity of the encoder is increased. To overcome an increase in the complexity of the encoder, a block to which dependent quantization is to be applied and a location to which dependent quantization is to be applied may be variously configured.

The video signal processing device may selectively apply dependent quantization and independent quantization. The encoder may generate a bitstream indicating quantization applied to a block is dependent quantization or independent quantization. The decoder may parse information included in a bitstream, may determine whether quantization applied to a corresponding block is dependent quantization or independent quantization, and may perform quantization based on the determined quantization method. Independent quantization refers to quantization designed so that a set of reconstructed transform coefficients available for a transform coefficient does not depend upon the value of a transform coefficient that precedes a current transform coefficient in a restoration order.

Whether dependent quantization is applied may be determined for each subblock. That is, the bottom-right subblock is a high frequency part and does not highly affect definition, and thus the video signal processing device may perform quantization using existing independent quantization. The top-left subblock is a low-definition part and highly affects definition, and thus the video signal processing device may perform quantization using dependent quantization. The encoder may generate a bitstream including information indicating whether dependent quantization is used for each subblock. The decoder may parse information included in a bitstream, may determine quantization to be applied to a corresponding subblock, and may perform quantization according to the determined quantization method.

A start location or end location to which dependent quantization is applied may be configured. Dependent quantization and independent quantization may be mixedly used for a single block. In this instance, coefficients to which dependent quantization is to be applied among the coefficients in a single block may be arranged consecutively in the restoration order. The video signal processing device may configure a start location and an end location in the restoration order among coefficients to which dependent quantization is applied. The start location and the end location may be configured based on at least one among the width or length of a current block, a quantization parameter, and temporal layer information. Information indicating the start location and the end location may be included in at least one of an SPS, PPS, a picture header, and a slice header. The encoder may generate a bitstream including information indicating a start location and an end location. The decoder may parse information indicating a start location and end location included in a bitstream, and may perform quantization. Information indicating a start location and an end location may be configured for each block. For example, the start location of dependent quantization may be a location a predetermined number of coefficients away from the location of a first coefficient different from 0 in the restoration order. In this instance, the predetermined number may be an integer greater than or equal to 1. The end location of dependent quantization may be a location a predetermined number of coefficients away from the start location in the restoration order. In this instance, the predetermined number may be an integer greater than or equal to 1. The end location may be configured up to the location (0, 0) of the top-left of a block which is the last one in the restoration order. A start location and an end location may be configured for each subblock. For example, (2, 2) of the 4×4 top-left subblock of FIG. 20 may be configured as a start location (a location corresponding to a quantization index of −6 in FIGS. 20), and (0, 0) may be configured as an end location (a location corresponding to a quantization index of −18 in FIG. 20). The restoration order may be a restoration order described in FIG. 13.

Dependent quantization may be applied for each subblock, independently. That is, a state may be initialized when restoration of coefficients of a subblock starts. In addition, an optimal path may be selected in a unit of a subblock. Therefore, processing at the level of subblock may be performed in parallel.

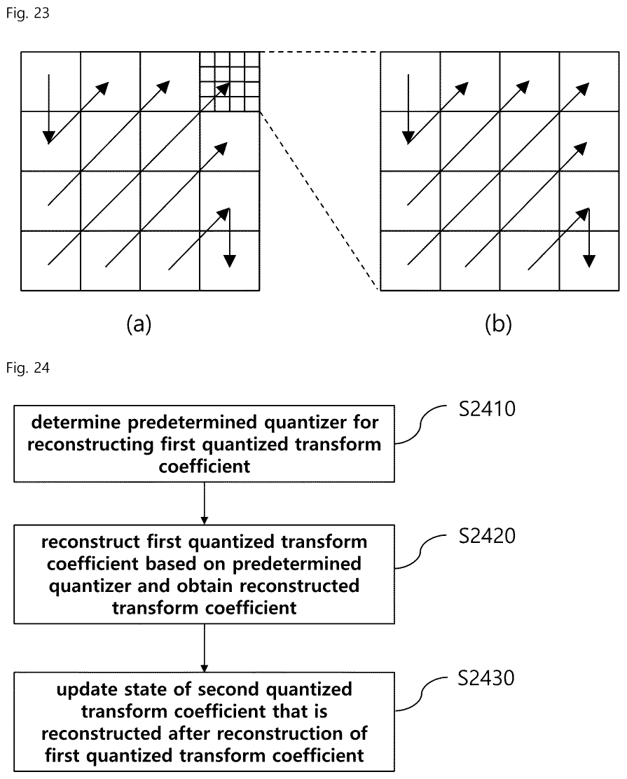

FIG. 23 is a diagram illustrating a scan order for performing dependent quantization according to an embodiment of the disclosure.

The scan order for performing dependent quantization may be the same as a restoration order that has been described with reference to FIG. 13. According to the restoration order described with reference to FIG. 13, a block may be scanned from a high-frequency part to a low-frequency part.

When an encoder performs rate-distortion optimized quantization (RDOQ), a low-frequency part may be highly affected by an error signal. Therefore, it is more effective way to search for an optimal path from a low-frequency part first before searching for an optimal path from a high-frequency part. Referring to FIG. 23, a scan order that is the reverse order of the scan order described with reference to FIG. 13 may be used. That is, a top-right diagonal scan order from the top-left of a block may be used.

The scan order may be selected among a horizontal scan, a vertical scan, or a diagonal scan by using at least one among the width or length of a current block, a ratio of the width and length of the current block, and an intra-prediction direction mode. For example, in the case in which the width of the current block is greater than the length of the current block, a vertical scan may be selected.

Dependent quantization may be a method that selects, based on a state, one of the various reconstructed values of a transform coefficient. The current block has a high probability of being similar to an adjacent block, and thus a quantization characteristic of transform coefficients of the current block may have a high probability of being similar to that of the adjacent block. That is, the reconstructed value of a transform coefficient that is determined in advance in an adjacent block may be used for determining a reconstructed value of a transform coefficient for the current block. To sensitively react to a change in characteristics of an adjacent block and the current block, a history-based state selection method or a method of selecting the number of states may be adoptively performed in units of blocks or in units of transform blocks. For example, in the case in which the number of states used in an adjacent block is 8, the encoder and the decoder may also configure the number of states for the current block to 8. Alternatively, in the case in which a transition procedure (e.g., a transition procedure described with reference to FIGS. 8 to 17) used in an adjacent block is an X transition procedure, the current block may also use the same transition procedure as that of the adjacent block.

FIG. 24 is a diagram illustrating a method of processing a video signal according to an embodiment of the disclosure.

Hereinafter, a method of processing a video signal which has been described with reference to FIG. 1 to FIG. 23 will be described with reference to FIG. 24.

A video signal processing device may determine a predetermined quantizer to reconstruct a first quantized transform coefficient in operation S2410. The predetermined quantizer may be any one of a first quantizer and a second quantizer, which are different from each other. The predetermined quantizer may be determined based on a state of the first quantized transform coefficient. The video signal processing device may reconstruct the first quantized transform coefficient based on the predetermined quantizer and may obtain a reconstructed transform coefficient in operation S2420. The video signal processing device may update a state of a second quantized transform coefficient that is reconstructed after restoration of the first quantized transform coefficient in operation S2430. The first quantized transform coefficient and the second quantized transform coefficient may be transform coefficients in a current block.

Based on the first quantized transform coefficient and the state of the first quantized transform coefficient, the state of the second quantized transform coefficient may be updated among a plurality of state candidates. In this instance, the plurality of state candidates may be determined based on a trellis path.

A quantizer for the state of the second quantized transform coefficient may be determined based on a parity bit of the first quantized transform coefficient.

The quantizer for the state of the first quantized transform coefficient and the quantizer for the state of the second quantized transformed coefficient may be different from each other. Conversely, the quantizer for the state of the first quantized transform coefficient and the quantizer for the state of the second quantized transformed coefficient may be the same.

The first quantized transform coefficient may be 0 or different from 0. In the case in which the first quantized transform coefficient is 0, the first quantized transform coefficient may not be reconstructed and only the state of the second quantized transform coefficient may be updated.

In the case in which the first quantized transform coefficient is 0, the state of the second quantized transform coefficient may be a predetermined state.

The number of the plurality of state candidates may be determined based on a temporal layer.

In addition, the number of the plurality of state candidates may be determined based on a quantization parameter of the current block.

In addition, the number of the plurality of state candidates may be determined based on syntax elements for restoring the second quantized transform coefficient.

In addition, the number of the plurality of state candidates may be determined based on the location of the second quantized transform coefficient in the current block.

The current block may be divided into a plurality of subblocks, and the first quantized transform coefficient and the second quantized transform coefficient may be located in different subblocks.

At least one of the quantized transform coefficients in the current block may be reconstructed based on dependent quantization, and at least one of the quantized transform coefficients in the current block, excluding the quantized transform coefficient reconstructed based on the dependent quantization, may be reconstructed based on independent quantization.

The second quantized transform coefficient may be reconstructed later than the first quantized transform coefficient in a restoration order, and the restoration order may be a top-left diagonal order.

The above methods (video signal processing methods) described in the present specification may be performed by a processor in a decoder or an encoder. Furthermore, the encoder may generate a bitstream that is decoded by a video signal processing method. Furthermore, the bitstream generated by the encoder may be stored in a computer-readable non-transitory storage medium (recording medium).

The present specification has been described primarily from the perspective of a decoder, but may function equally in an encoder. The term “parsing” in the present specification has been described in terms of the process of obtaining information from a bitstream, but in terms of the encoder, may be interpreted as configuring the information in a bitstream. Thus, the term “parsing” is not limited to operations of the decoder, but may also be interpreted as the act of configuring a bitstream in the encoder. Furthermore, the bitstream may be configured to be stored in a computer-readable recording medium.

The above-described embodiments of the present invention may be implemented through various means. For example, embodiments of the present invention may be implemented by hardware, firmware, software, or a combination thereof.

For implementation by hardware, the method according to embodiments of the present invention may be implemented by one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, and the like.

In the case of implementation by firmware or software, the method according to embodiments of the present invention may be implemented in the form of a module, procedure, or function that performs the functions or operations described above. The software code may be stored in memory and driven by a processor. The memory may be located inside or outside the processor, and may exchange data with the processor by various means already known.

Some embodiments may also be implemented in the form of a recording medium including computer-executable instructions such as a program module that is executed by a computer. Computer-readable media may be any available media that may be accessed by a computer, and may include all volatile, nonvolatile, removable, and non-removable media. In addition, the computer-readable media may include both computer storage media and communication media. The computer storage media include all volatile, nonvolatile, removable, and non-removable media implemented in any method or technology for storing information such as computer-readable instructions, data structures, program modules, or other data. Typically, the communication media include computer-readable instructions, other data of modulated data signals such as data structures or program modules, or other transmission mechanisms, and include any information transfer media.

The above-mentioned description of the present invention is for illustrative purposes only, and it will be understood that those of ordinary skill in the art to which the present invention belongs may make changes to the present invention without altering the technical ideas or essential characteristics of the present invention and the invention may be easily modified in other specific forms. Therefore, the embodiments described above are illustrative and are not restricted in all aspects. For example, each component described as a single entity may be distributed and implemented, and likewise, components described as being distributed may also be implemented in an associated fashion.

The scope of the present invention is defined by the appended claims rather than the above detailed description, and all changes or modifications derived from the meaning and range of the appended claims and equivalents thereof are to be interpreted as being included within the scope of present invention.

1. A video signal decoding device comprising a processor,
wherein the processor is configured to:
determine a predetermined quantizer to reconstruct a first quantized transform coefficient, wherein the predetermined quantizer is one of a first quantizer and a second quantizer, which are different from each other, and the predetermined quantizer is determined based on a state of the first quantized transform coefficient;
reconstruct the first quantized transform coefficient based on the predetermined quantizer, and obtain a reconstructed transform coefficient; and
update a state of a second quantized transform coefficient that is reconstructed after reconstruction of the first quantized transform coefficient,
wherein the first quantized transform coefficient and the second quantized transform coefficient are transform coefficients in a current block.

2. The video signal decoding device of claim 1, wherein the state of the second quantized transform coefficient is updated among a plurality of state candidates based on the first quantized transform coefficient and the state of the first quantized transform coefficient.

3. The video signal decoding device of claim 2, wherein the plurality of state candidates is determined based on a trellis path.

4. The video signal decoding device of claim 1, wherein a quantizer for the state of the second quantized transform coefficient is determined based on a parity bit of the first quantized transform coefficient.

5. The video signal decoding device of claim 1, wherein the quantizer for the state of the first quantized transform coefficient and the quantizer for the state of the second quantized transform coefficient are different from each other.

6. The video signal decoding device of claim 1, wherein the quantizer for the state of the first quantized transform coefficient and the quantizer for the state of the second quantized transform coefficient are the same.

7. The video signal decoding device of claim 1, wherein the first quantized transform coefficient is 0 or different from 0, and
wherein, when the first quantized transform coefficient is 0, the first quantized transform coefficient is not reconstructed and only the state of the second quantized transform coefficient is updated.

8. The video signal decoding device of claim 5, wherein, when the first quantized transform coefficient is 0, the state of the second quantized transform coefficient is a predetermined state.

9. The video signal decoding device of claim 2, wherein the number of the plurality of state candidates is determined based on a temporal layer.

10. The video signal decoding device of claim 2, wherein the number of the plurality of state candidates is determined based on a quantization parameter of the current block.

11. The video signal decoding device of claim 2, wherein the number of the plurality of state candidates is determined based on syntax elements for reconstructing the second quantized transform coefficient.

12. The video signal decoding device of claim 2, wherein the number of the plurality of state candidates is determined based on a location of the second quantized transform coefficient in the current block.

13. The video signal decoding device of claim 11, wherein the current block is divided into a plurality of subblocks, and
wherein the first quantized transform coefficient and the second quantized transform coefficient are located in different subblocks.

14. The video signal decoding device of claim 1, wherein at least one of the quantized transform coefficients in the current block is reconstructed based on dependent quantization, and
wherein at least one of the quantized transform coefficients in the current block, excluding a quantized transform coefficient reconstructed based on the dependent quantization, is reconstructed based on independent quantization.

15. The video signal decoding device of claim 1, wherein the second quantized transform coefficient is reconstructed later than the first quantized transform coefficient in a reconstruction order, and
wherein the reconstruction order is a top-left diagonal order.

16. A video signal encoding device comprising a processor,
wherein the processor is configured to obtain a bitstream decoded according to a decoding method, the decoding method comprising:
determining a predetermined quantizer to reconstruct a first quantized transform coefficient, wherein the predetermined quantizer is one of a first quantizer and a second quantizer, which are different from each other, and the predetermined quantizer is determined based on a state of the first quantized transform coefficient;
reconstructing the first quantized transform coefficient based on the predetermined quantizer and obtaining a reconstructed transform coefficient; and
updating a state of the second quantized transform coefficient that is reconstructed after reconstruction of the first quantized transform coefficient, and
wherein the first quantized transform coefficient and the second quantized transform coefficient are transform coefficients in a current block.

17. The video signal encoding device of claim 16, wherein the state of the second quantized transform coefficient is updated among a plurality of state candidates, based on the first quantized transform coefficient and the state of the first quantized transform coefficient.

18. The video signal encoding device of claim 16, wherein the quantizer for the state of the second quantized transform coefficient is determined based on a parity bit of the first quantized transform coefficient.

19. The video signal encoding device of claim 16, wherein the first quantized transform coefficient is 0 or different from 0, and
wherein, when the first quantized transform coefficient is 0, the first quantized transform coefficient is not reconstructed and only a state of the second quantized transform coefficient is updated.

20. A computer-readable non-transitory storage medium storing a bitstream that is decoded according to a decoding method, the decoding method comprising:
determining a predetermined quantizer to reconstruct a first quantized transform coefficient, wherein the predetermined quantizer is one of a first quantizer and a second quantizer, which are different from each other, and the predetermined quantizer is determined based on a state of the first quantized transform coefficient;
reconstructing the first quantized transform coefficient based on the predetermined quantizer and obtaining a reconstructed transform coefficient; and
updating a state of a second quantized transform coefficient that is reconstructed after reconstruction of the first quantized transform coefficient, and
wherein the first quantized transform coefficient and the second quantized transform coefficient are transform coefficients in a current block.
